(19) United States
(12) Patent Application Publication
(10) Pub. No.: US 2024/0095605 A1
(43) Pub. Date: Mar. 21, 2024

(54) SYSTEMS AND METHODS FOR AUTOMATED RISK ANALYSIS OF MACHINE LEARNING MODELS

(71) Applicants: Daniel Fylstra, Incline Village, NV (US); Oleg Shirokikh, Reno, NV (US)

(72) Inventors: Daniel Fylstra, Incline Village, NV (US); Oleg Shirokikh, Reno, NV (US)

(21) Appl. No.: 18/369,153

(22) Filed: Sep. 16, 2023

Related U.S. Application Data
(60) Provisional application No. 63/407,281, filed on Sep. 16, 2022.

(51) Int. Cl. G06N 20/20; G06N 7/00

(52) U.S. Cl. CPC G06N 20/20; G06N 7/00

(57) ABSTRACT

There is risk or uncertainty that a predictive model, such as a machine learning model, that has been fitted to a dataset of known cases will not produce the same distribution of predictions or outcomes when applied to future cases. To assess risk, the dataset of known cases is statistically assessed using best-fit probability distributions and correlations for one or more features of the dataset, then new cases are generated to produce a synthetic dataset that has statistical characteristics similar to the known dataset. The predictive model can be applied to the synthetic dataset. A comparison of the distribution of predictions by the predictive model on the known dataset and on the synthetic dataset can be made. Significant variations in the distribution of predictions or outcomes can indicate that the model is not suitable for future cases. Lack of such variations can increase confidence and willingness to use the model.

### CROSS REFERENCE TO RELATED APPLICATIONS

This application claims priority to U.S. Provisional Patent Application Ser. No. 63/407,281 filed 16 Sep. 2022, the entire contents of which are incorporated herein by reference.

### FIELD OF THE INVENTION

This invention relates to the use of predictive models, and in particular Machine Learning (ML) models and to determining the uncertainty and risk in implementing such models in production use.

### BACKGROUND OF THE INVENTION

Machine learning (“ML”) models have come into widespread use in many industries in recent years. Such models are designed to accept a set of input values, commonly called features or independent variables, and calculate an output value, called a prediction or, as a special case, a classification. A prediction is typically a continuous numerical value, while a classification is one of a few predefined category or class values—in the simplest case two (binary) classes.

To make useful predictions, such models are first trained through supervised learning on a dataset of known cases, in which each case includes values for each feature or independent variable (or some subset of the total set of features and independent variables) and the output value to be predicted. The training process fits parameters of the model so that the model accurately predicts known cases. The dataset of known cases is often split into a training set, a validation set, and optionally a test set. The model is validated and/or refined based on its predictions for the validation set and then tested on the test set by predicting output values over the known cases.

The performance of a ML model may be compared to the performance of other trained models or a baseline model with no predictive power, but such comparisons are based on the dataset of known cases. Future cases are simply assumed to be similar to known cases.

A trained and validated ML model may then be put into production use to make predictions on future cases as they arise. Such future cases are expected to be similar to known cases, but future cases often will not be identical to known cases on which the model was trained and validated, and thus, the actual performance of the model is uncertain. This uncertainty is not generally studied or quantified prior to production use of a model.

The predictions of a ML model are not typically end results themselves, but they serve as guidance for action that leads to outcomes such as financial outcomes. A model may predict the likelihood that a borrower will default on a loan, for example, but the outcome or financial consequence of a default depends on other factors such as the decision to make a loan, the amount of the loan, its interest rate, and other variables. The outcome has uncertainty. Such outcomes or financial consequences are not often calculated even for the dataset of known cases, and neither financial consequences nor their associated financial risks are calculated or evaluated for possible future cases.

The predictions of a model in production use may be recorded and assessed. If the predictions are worse than the predictions observed for the known cases used for training, or if the predictions become worse over time, then the model may be retrained using new data from the new cases. Financial loss or other unfavorable outcomes, however, will have already occurred before such retraining is implemented. In some specialized use cases such as autonomous vehicles dealing with “adversarial input data”, specific measures and mitigations have been proposed to avoid unfavorable outcomes such as collisions. But for the vast majority of models and use cases, the risk of financial loss and other unfavorable outcomes from production use cannot be assessed in advance by simply training, validating, or even testing a ML model, nor can the risk be assessed by comparison of the ML model to alternative ML models. Current best practices therefore focus on improved training of ML models.

ML models can be improved by training the models on larger or additional data. When additional data is unavailable, then existing datasets may be augmented by additional cases produced by synthetic data generation (“SDG”). Synthetic data is also employed to avoid legal and regulatory restrictions on the use of data including restrictions on data containing personally identifiable information and/or protected health information, because synthetic data does not correspond to any real-world person. Synthetic data may be generated using a variety of methods including distribution fitting and Monte Carlo methods, generative adversarial networks (“GANs”), variational auto-encoders (“VAEs”), hidden Markov models (“HMMs”), and others.

Efforts to assess the uncertainty and risk of projects, strategies, and business or government operations are collectively described as risk analysis. These efforts generally rely on a custom model designed by a human analyst and expressed in either programming code, a special modeling language, or a spreadsheet. If data for some uncertain variable(s) affecting the model is available, then distribution fitting may be employed. A human analyst, who ideally possesses knowledge of the origins of the existing data, makes hypotheses about an underlying process and the probability distribution(s) that would describe the process and then tests these hypotheses using distribution fitting software and visual chart inspection. Risk analysis then proceeds by applying Monte Carlo methods to generate simulation trials. The behavior of a human-designed custom model on each trial is recorded, and the results are summarized with statistics, charts, and graphs for a human decision maker.

Conventional risk analysis methods are expensive and time-consuming to apply to ML models. Training datasets often include numerous features with limited provenance of their origins. Hundreds of known probability distributions exist, and different distributions could apply to each feature. In many cases, only some of the numerous features are found to have predictive value, and many of the predictive features correlate and therefore may be partially or completely redundant. In typical projects, many ML models are built, but the models can only be compared in light of the limitations described above. Existing methods to perform risk analysis on ML models are therefore infeasible or impractical and otherwise provide limited value.

What is required is an improved system and method for performing risk analysis of a predictive model, including a machine learning model, prior to deployment of the predictive model or production use.

### SUMMARY OF ONE EMBODIMENT OF THE INVENTION

### Advantages of One or More Embodiments of the Present Invention

The various embodiments of the present invention may, but do not necessarily, achieve one or more of the following advantages:

The ability to conduct a risk assessment of a predictive model on potential future cases prior to implementation of the model;

The ability to perform a risk assessment of a predictive model quickly and with minimal user input;

The ability to provide a risk assessment of a predictive model to a person without prior training in risk analysis methods;

The ability to display risk or uncertainty for a predictive model in a visual and numeric form;

The ability to generate a dataset representative of future cases that has similar statistical characteristics to a known dataset on which a predictive model was trained and validated;

The ability to compare comparable predictive models for risk and/or uncertainty.

These and other advantages may be realized by reference to the remaining portions of the specification, claims, and abstract.

### BRIEF DESCRIPTION OF ONE EMBODIMENT OF THE PRESENT INVENTION

In one aspect, the invention provides a method to assess at least one of uncertainty or risk in applying a predictive model to future cases wherein the predictive model has been fitted on a dataset of known cases each comprising input values for a plurality of features. The method may comprise statistically assessing a plurality of input values for a plurality of features of a plurality of the known cases of the dataset of known cases to generate a dataset of synthetic cases that exhibits overall statistical properties at least substantially similar to corresponding statistical properties of the dataset of known cases. The predictive model may be applied to the dataset of synthetic cases to obtain predictions (termed “synthetic predictions” for convenience). The method may further comprise analyzing at least one of a difference in a distribution of predictions of the model on the synthetic data (synthetic prediction distribution) versus a distribution of predictions of the model on the known data (known prediction distribution); and a difference in a distribution of outcomes from the predictions of the model on the synthetic data (synthetic outcome distribution) versus a distribution of outcomes from the predictions of the model on the known data (known outcome distribution); to estimate at least one of an uncertainty or risk of applying the model to future cases.

In one aspect, the invention provides a system to assess at least one of uncertainty or risk in applying a predictive model to future cases wherein the predictive model has been fitted on a dataset of known cases each comprising input values for a plurality of features. The system may comprise at least one processor and at least one operatively associated memory. The at least one processor may be programmed to perform statistically assessing a plurality of input values for a plurality of features of a plurality of the known cases of the dataset of known cases to generate a dataset of synthetic cases that exhibits overall statistical properties at least substantially similar to corresponding statistical properties of the dataset of known cases. The predictive model may be applied to the dataset of synthetic cases to obtain synthetic predictions. The processor may perform analyzing at least one of a difference in a distribution of predictions of the model on the synthetic data (synthetic prediction distribution) versus a distribution of predictions of the model on the known data (known prediction distribution); and a difference in a distribution of outcomes from the predictions of the model on the synthetic data (synthetic outcome distribution) versus a distribution of outcomes from the predictions of the model on the known data (known outcome distribution); to estimate at least one of an uncertainty or risk of applying the model to future cases.

In one aspect, the invention provides a computer-readable medium comprising computer-executable instructions that when executed by at least one processor cause the at least one processor to perform a method to assess at least one of uncertainty or risk in applying a predictive model to future cases wherein the predictive model has been fitted on a dataset of known cases each comprising input values for a plurality of features. The method may comprise statistically assessing a plurality of input values for a plurality of features of a plurality of the known cases of the dataset of known cases to generate a dataset of synthetic cases that exhibits overall statistical properties at least substantially similar to corresponding statistical properties of the dataset of known cases. The predictive model may be applied to the dataset of synthetic cases to obtain synthetic predictions. The method may further comprise analyzing at least one of a difference in a distribution of predictions of the model on the synthetic data (synthetic prediction distribution) versus a distribution of predictions of the model on the known data (known prediction distribution); and a difference in a distribution of outcomes from the predictions of the model on the synthetic data (synthetic outcome distribution) versus a distribution of outcomes from the predictions of the model on the known data (known outcome distribution); to estimate at least one of an uncertainty or risk of applying the model to future cases.

The above description sets forth, rather broadly, a summary of one embodiment of the present invention so that the detailed description that follows may be better understood and contributions of the present invention to the art may be better appreciated. Some of the embodiments of the present invention may not include all of the features or characteristics listed in the above summary. There are, of course, additional features of the invention that will be described below and will form the subject matter of claims. In this respect, before explaining at least one preferred embodiment of the invention in detail, it is to be understood that the invention is not limited in its application to the details of the construction and to the arrangement of the components set forth in the following description or as illustrated in the drawings. The invention is capable of other embodiments and of being practiced and carried out in various ways. Also, it is to be understood that the phraseology and terminology employed herein are for the purpose of description and should not be regarded as limiting.

### BRIEF DESCRIPTION OF THE DRAWINGS

FIG. 1 substantially depicts a comparison of a typical ML model training and use with risk analysis of a model in accordance with an embodiment of the present specification;

FIG. 2 substantially depicts a first embodiment showing a data set of known cases commonly called a “training dataset”;

FIG. 3 substantially depicts a first step for synthetic data generation wherein the features of the training set for statistical assessment are selected;

FIG. 4 substantially depicts a step for selecting the statistical algorithm(s) to apply to the features selected in FIG. 3;

FIG. 5 substantially depicts a step for customizing the algorithm(s) of FIG. 4

FIG. 6 shows an interface for statistical comparison of features of a known data set with corresponding features of a synthetic data set;

FIG. 7 shows a statistical comparison for one specific feature selected in the interface of FIG. 6;

FIG. 8 substantially depicts an embodiment of an interface for selecting features of an input dataset for use in training and validating a ML model based on a Classification and Regression Tree (CaRT) methodology;

FIG. 9 substantially depicts an interface for partitioning the known dataset into “training” and “validation” sets and selecting other options for the CaRT methodology;

FIG. 10 substantially depicts an interface for executing a risk analysis simulation on the CaRT model;

FIG. 11 substantially depicts an output chart for the risk analysis of the CaRT model;

FIG. 12 substantially depicts an embodiment of an interface for selecting features of an input dataset for use in training and validating a ML model based on a Logistic Regression methodology;

FIG. 13 substantially depicts an interface for partitioning the known dataset into “training” and “validation” sets and selecting other options for the Logistic Regression methodology;

FIG. 14 substantially depicts an interface for executing a risk analysis simulation on the Logistic Regression model;

FIG. 15 substantially depicts an output chart for the risk analysis of the Logistic Regression model;

FIG. 16 substantially depicts an outcome or consequence (e.g. financial loss) of implementing the Logistic Regression model;

FIG. 17 substantially depicts an embodiment of an interface for selecting features of an input dataset for use in training and validating a ML model based on a Bagging Classification methodology;

FIG. 18 substantially depicts an interface for partitioning the known dataset into “training” and “validation” sets and selecting other options for the Bagging Classification methodology;

FIG. 19 substantially depict an interface for executing a risk analysis simulation on the Bagging Classification model;

FIG. 20 substantially depicts an output chart for the risk analysis of the Bagging Classification model;

FIG. 21 substantially depicts an outcome or consequence (e.g. financial loss) of implementing the Bagging Classification model;

FIG. 22 substantially depicts user commands to train a regression model and perform risk analysis in a high level RASON modelling language embodiment;

FIG. 23, in combination with the bottom of FIG. 22, substantially depicts user commands to summarize risk analysis results in a high level RASON modelling language embodiment;

FIG. 24 substantially depicts user steps to create a regression model in a RASON cloud service;

FIG. 25 substantially depicts user steps to train a model and perform risk analysis in a RASON cloud service;

FIG. 26 substantially depicts risk analysis output in JavaScript Object Notation in a RASON cloud service;

FIG. 27 substantially depicts risk analysis output in OData Tabular Form in a RASON cloud service;

FIG. 28 substantially depicts user steps to create risk analysis summarization in a RASON cloud service;

FIG. 29 substantially depicts user steps to run risk analysis summarization in a RASON cloud service;

FIG. 30 substantially depicts risk analysis summary in JavaScript Object Notation in a RASON cloud service;

FIG. 31 substantially depicts risk analysis summary in OData Tabular Form in a RASON cloud service;

FIG. 32 substantially depicts an embodiment of user commands to train a regression model and perform risk analysis expressed in C# programming notation;

FIG. 33 substantially depicts an embodiment of user commands to train a regression model and perform risk analysis expressed in Microsoft Visual Studio™; and

FIG. 34 substantially depicts an embodiment of risk analysis console output in Microsoft Visual Studio™.

### DESCRIPTION OF CERTAIN EMBODIMENTS OF THE PRESENT INVENTION

In the following detailed description of the preferred embodiments, reference is made to the accompanying drawings, which form a part of this application. The drawings show, by way of illustration, specific embodiments in which the invention may be practiced. It is to be understood that other embodiments may be utilized and structural changes may be made without departing from the scope of the present invention.

The present inventors have recognized that there is a risk that future cases for a predictive model in production use may be significantly different from the known cases that were used to develop and test the model prior to deployment in production. When the predictive model is used on such future cases, there is a risk or uncertainty that the predictive model will produce different predictions and outcomes compared to the training dataset and the model may thus fail to meet its intended objectives. Such risk may manifest itself as a financial loss, reputation loss, or simply failure of the model to reliably make predictions, amongst other undesirable outcomes for a business. Thus, a system and method for analyzing this risk has been developed as will be described herein. Embodiments as will be described may determine this risk, e.g. qualitatively or quantitively, as applied to the predictive model results. It should be noted that the risk or uncertainty contemplated here is the risk of the predictive model's use as a whole, not the risk or uncertainty of individual predictions or outcomes from individual cases.

Typically, a predictive model will be implemented in order to achieve a goal. Typically, the goal will be a business outcome. For example, a predictive model may be designed to assess loan application data, and predict the likelihood of default (the prediction). Based on the prediction, a decision will be made to approve or deny the loan. The overall goal of the predictive model, distinct from any individual outcome, may be to accurately predict whether a group of loan applicants are likely to default and thereby aid the loan approval process. If the predictive model under predicts defaults across the group, then the lender may suffer undue financial losses. However, if the predictive model over predicts defaults across the group, then the lender may deny loans that might otherwise be low risk, thereby denying the lender potential customers and profits. In another example, a predictive model may be designed to predict health outcomes for a person given a drug or treatment, based on health, lifestyle and family history inputs for the person. The performance of the model can be tested using known cases. If the model performs satisfactorily, a decision may be made to use the model to aid in treatment decisions. In such use, future cases will be different from the known cases, and there is a risk that the model's predictions will vary from those seen on known cases, yielding significant uncertainty in health outcomes.

The present inventors have recognized that achieving the goals of any predictive model carries an associated risk or uncertainty. Specifically, the inventors have recognized that once deployed in production use, the future cases where the model is applied may yield unacceptable variations in the distribution of predictions and outcomes compared with the known cases on which the model was developed, tested and approved. It is often expected that future cases with similarity to the known cases would produce a similar distribution of predictions and outcomes; the inherent uncertainty is often neglected. But in many real-world situations, the magnitude of this uncertainty is great enough to significantly impact whether the model's goals will be achieved. The present inventors have therefore developed methods to easily and quickly assess the risk, qualitatively and/or quantitively, that the predictive model will continue to produce the desired statistical distributions for predictions and outcomes when deployed for production use, as will be described in more detail below.

The present methods of automated risk analysis of ML models and other predictive models have been developed to, in some embodiments, minimize user interactions and/or to display outputs, including statistics and visual aids, upon which informed decisions may be made based upon previously-inaccessible risk analysis data. These methods rely upon the generation of synthetic datasets (in some embodiments, without any synthetic output values) to assess the performance and behavior of ML models or other predictive models, which is fundamentally different from merely training ML models on synthetic data and synthetic output values, and which allows for risk analysis data that was previously inaccessible.

The methods combine and automate a complex series of steps and, in some embodiments, advantageously require mere seconds-to-minutes of time such that, in some embodiments, their integration into existing processes presents little burden while nevertheless providing decision makers with up to a full suite of risk analysis tools. In some embodiments, the methods of the disclosure add value by identifying risky ML models and other predictive models prior to production use. In some embodiments, this serves to avoid wasted effort, errors, loss, and other unfavorable outcomes while, in some embodiments, instilling greater confidence that appropriately-performing models will meet expectations during production use.

In some embodiments, the methods can be utilized both to compare the performance of different ML models and/or other predictive models as well as to, in some embodiments, guide decision making based on their aggregate predictions, for example, to improve the likelihood that loans approved across various income groups will meet goals without taking undue financial risk.

Advantages of one or more of the embodiments described below include that they make complex mathematical, analytical, and data processing techniques available with great speed to the ordinary user of personal computer technology, with simplified user interfaces, at much less cost, and with greater reliability than has typically been the case in the past. One or more embodiments address the need of business analysts using ordinary spreadsheet software on PCs, “citizen data scientists” using web and mobile platforms for rapid application development, and professional software developers—each of whom may have limited background in machine learning and/or in the mathematical and statistical techniques used for risk analysis.

Many modifications and other implementations of the disclosure set forth herein will come to mind to one skilled in the art to which this disclosure pertains having the benefit of the teachings presented in the foregoing descriptions and the associated drawings. Therefore, it is to be understood that the disclosure is not to be limited to the specific implementations disclosed, and that modifications and other implementations are intended to be included within the scope of the appended claims. Moreover, although the foregoing descriptions and the associated drawings describe example implementations in the context of certain example combinations of elements and/or functions, it should be appreciated that different combinations of elements and/or functions may be provided by alternative implementations without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

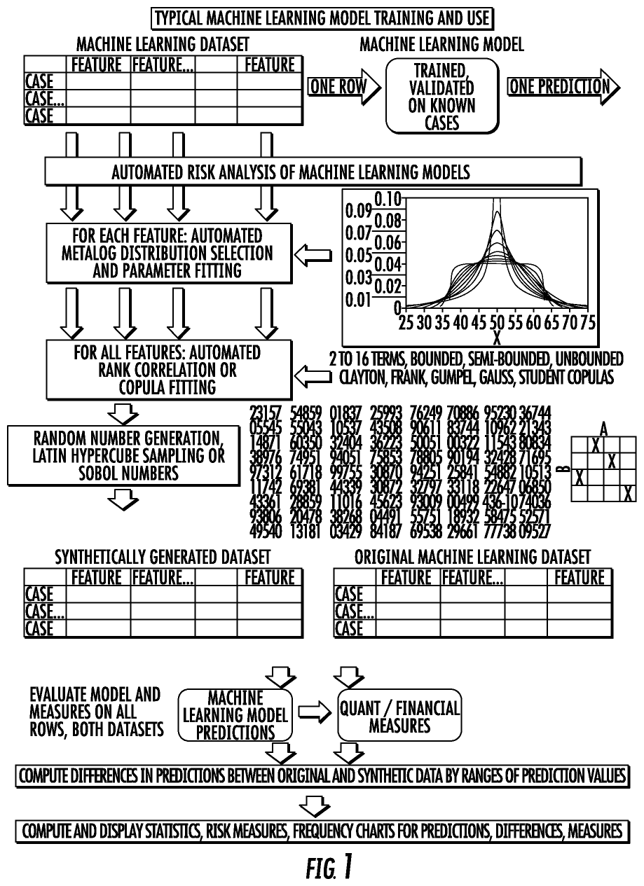

FIG. 1 is a diagram that compares typical ML model training and use (top; vertical, right-pointing arrows) with risk analysis methods of this specification (bottom; horizontal, downward-pointing arrows). A typical ML model is trained and validated on known datasets and then put into production use without risk analysis. The risk analysis methods of the disclosure operate by creating a synthetic dataset by statistically assessing one or more known datasets, for example, by automated Metalog probability distribution selection and parameter fitting, automated rank correlation or copula fitting, and random number (“Monte Carlo”) generation, stratified (e.g. Latin Hypercube) sampling, or Sobol number generation, and then assess the performance of a predictive model against the synthetic dataset relative to the known dataset using quantitative measures, such as differences between result frequencies and/or financial outcomes and/or statistics and/or visualization tools. The disclosure sets forth methods to automatically generate the foregoing risk analysis tools in seconds in some embodiments, to allow for better decision making before putting a ML model or other predictive model into production use.

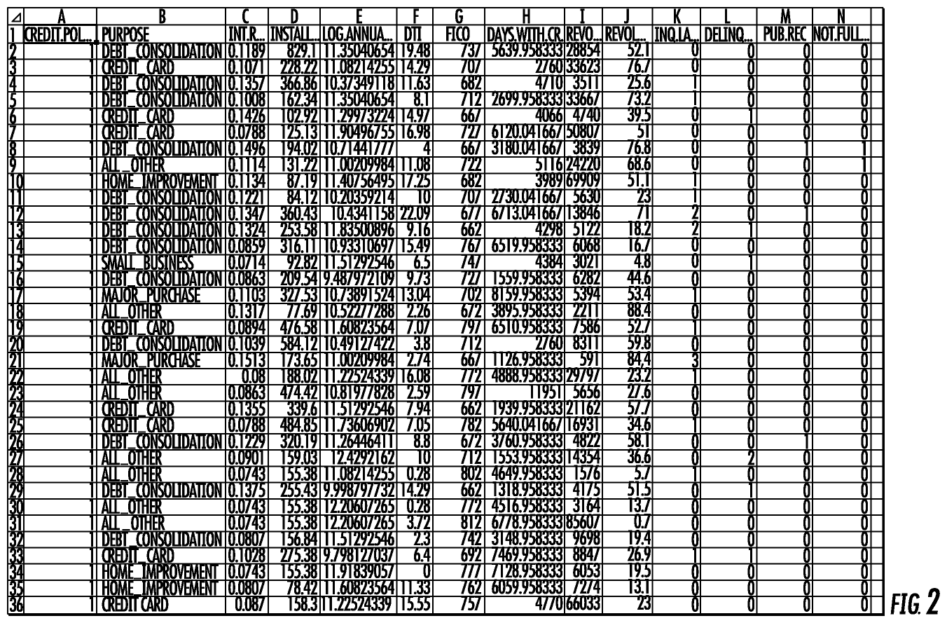

FIG. 2 (Microsoft Excel Embodiment) depicts a first embodiment showing a dataset of known cases commonly called a “training dataset”, which is organized in a spreadsheet and further described in the Exemplification section below and in Table 1. Rows 2-36 correspond to known cases. The cells of rows 2-36, columns A-M set forth known features of the type set forth in row 1. The cells of rows 2-36, column N set forth known values 1 or 0 (denoted “outcomes” in this dataset, but distinct from the full outcomes or financial consequences to a lender). The terms set forth in the cells of row 1, which include the features and the outcome, are defined in Table 1 of the Exemplification.

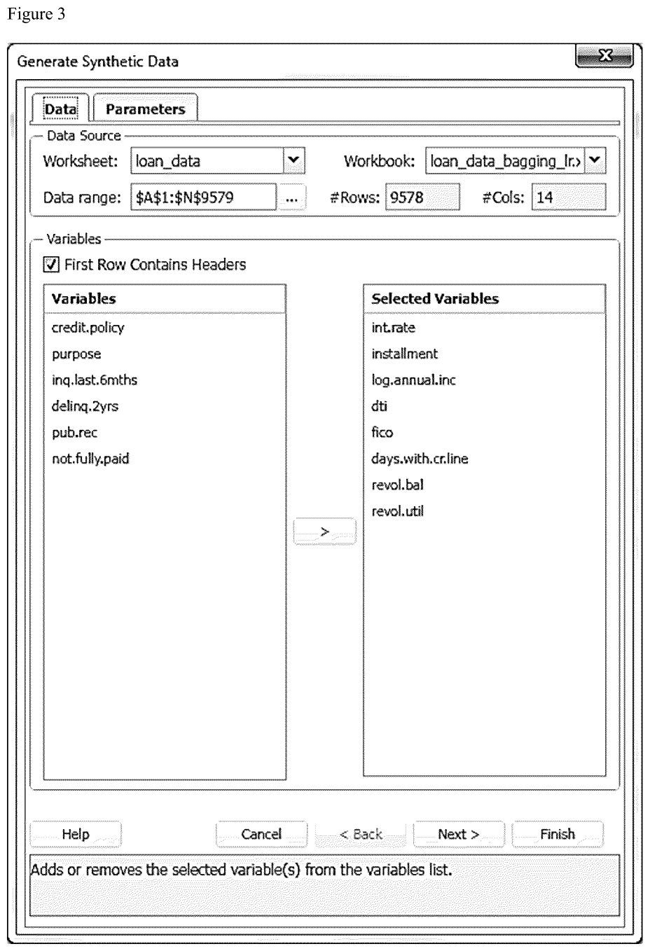

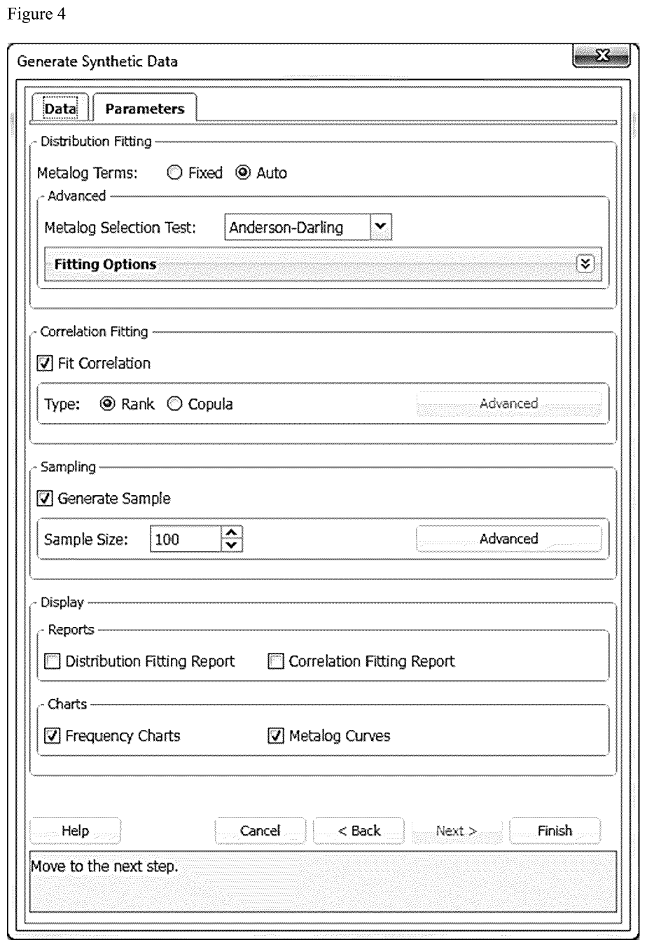

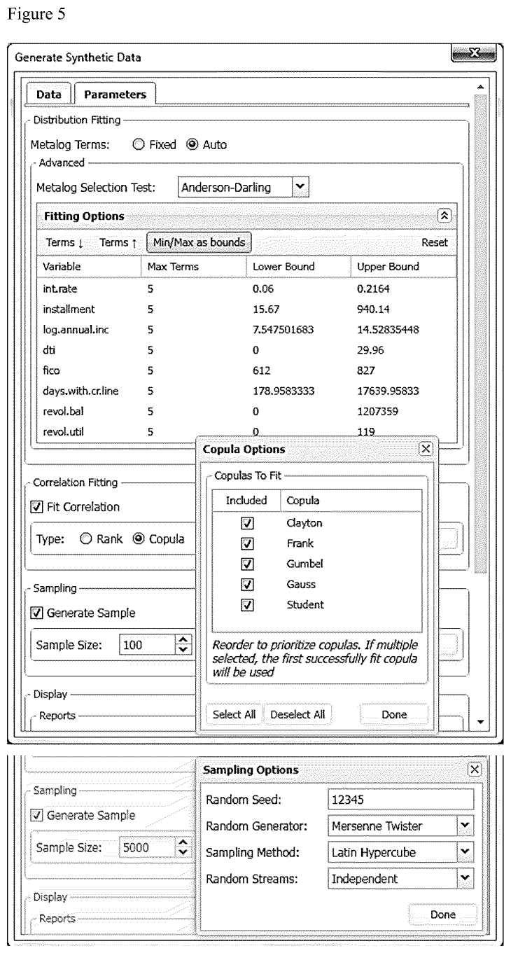

FIGS. 3, 4 and 5 teach the steps that a user carries out in Microsoft Excel, in one embodiment, to perform the subset of the risk analysis process that uses synthetic data generation (SDG). This SDG process is carried out automatically and “silently” as part of risk analysis during the training of a ML model, as illustrated in later figures for three types of ML models (CaRT, Logistic Regression, and Ensemble Bagging); it may also be used by itself, so it is detailed once, and user options are shown in these figures.

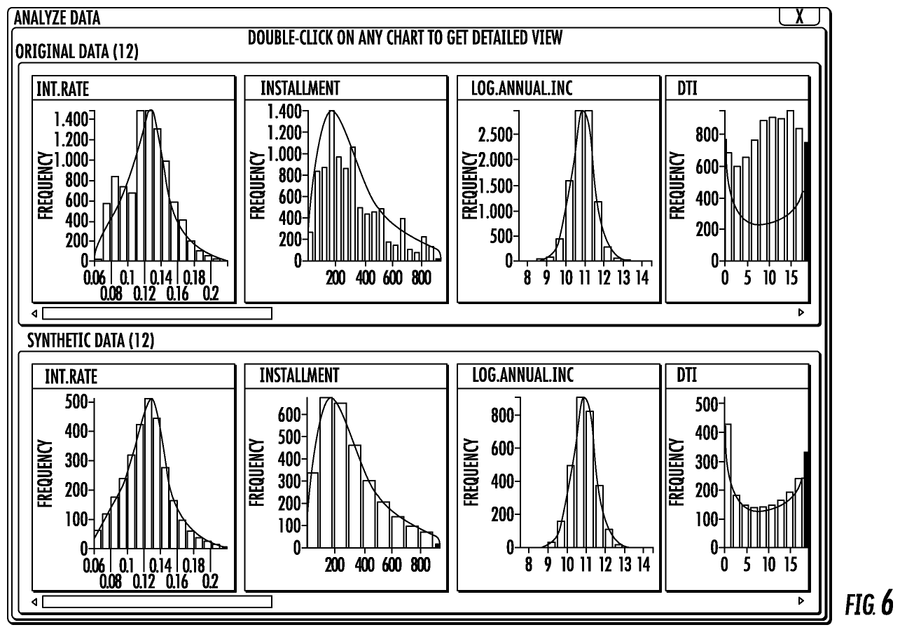

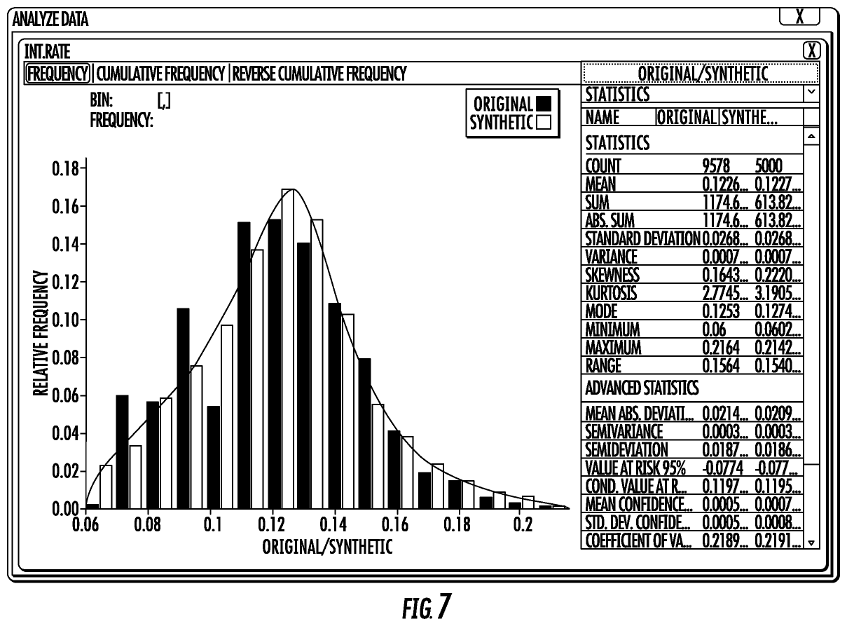

FIG. 6 displays histograms for synthetic data generation, displayed when the steps in FIGS. 3, 4 and 5 are carried out, that allow for the visual comparison of the statistical characteristics of known features of a training dataset (top row of panels) with the statistical characteristic of synthetic features of a synthetic dataset (bottom row of panels). The top and bottom panels in each column of panels correspond to the same feature. The line that overlays each histogram is the probability density function (PDF) of a Metalog distribution best-fit to the known cases for that feature, from which the synthetic data values for the same feature were generated. While the present disclosure is not limited to Metalog distributions, this family of distributions is advantageous in the context of fully-automated distribution selection and parameter fitting. Through the interface of FIG. 6, the similarity of the statistical characteristics of the known dataset and the synthetic dataset can be observed. FIG. 7 displays the detailed chart and statistics that appear when the user double-clicks on an individual chart in the panel of charts in FIG. 6.

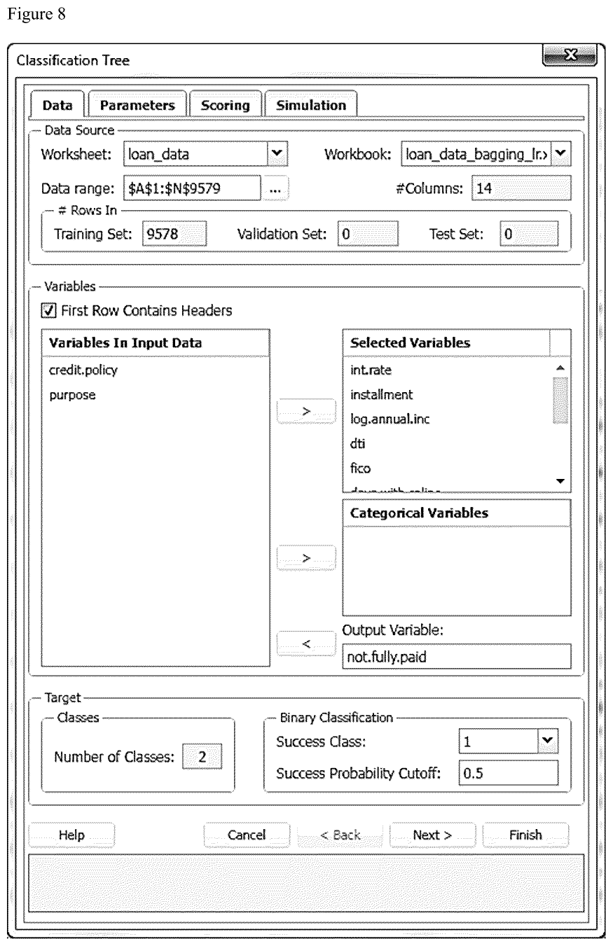

FIGS. 8, 9 and 10 teach the steps that a user carries out in Microsoft Excel, in one embodiment, to train and validate a ML model using the Classification and Regression Tree (CaRT) methodology, and perform a risk analysis “on the fly” of the CaRT model so trained and validated—using the Simulation tab. Since the risk analysis process is fully automated, with optional user customizations available, the only step the user must take for the risk analysis is to check the box labeled “Simulate Response Prediction”. In this embodiment, the model is trained to predict the likelihood of a loan default.

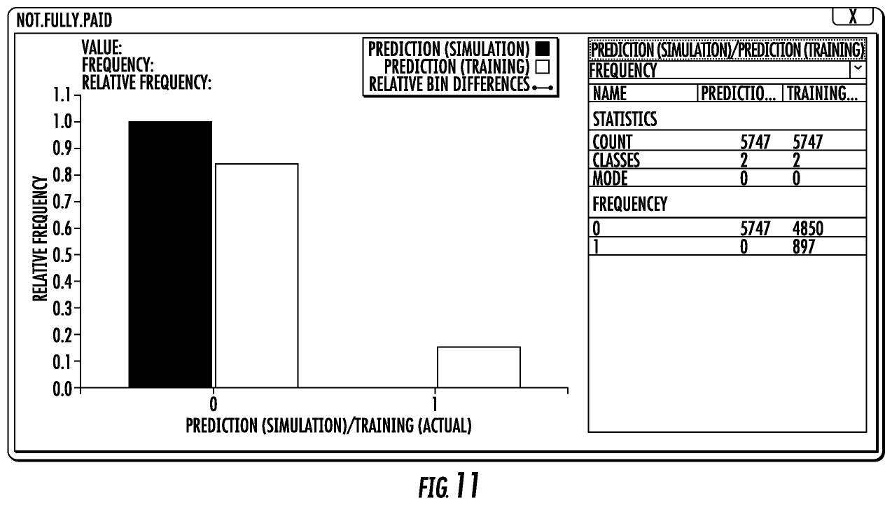

FIG. 11 comprises a histogram (left) and the counts used to generate the histogram (right). The histogram depicts the frequency of loan defaults predicted by a trained Classification Tree (“CaRT”) ML model for a known (“Training”) dataset and a synthetic (“Simulation”) dataset, which allows risk analysis of the trained CaRT ML model prior to production use. This comparison, in visual and numeric form, of ML model behavior on known versus synthetic cases allows a user to assess how a model's behavior may change when deployed on future cases; a histogram is one embodiment for visualization, but other embodiments will be evident to a person skilled in the art. The user is able to view, in visual and numeric form, the statistical variation between the known dataset and the synthetic dataset (e.g. FIGS. 6 and 7). and compare this to the variation produced in the predictions and/or outcomes (e.g. FIG. 11).

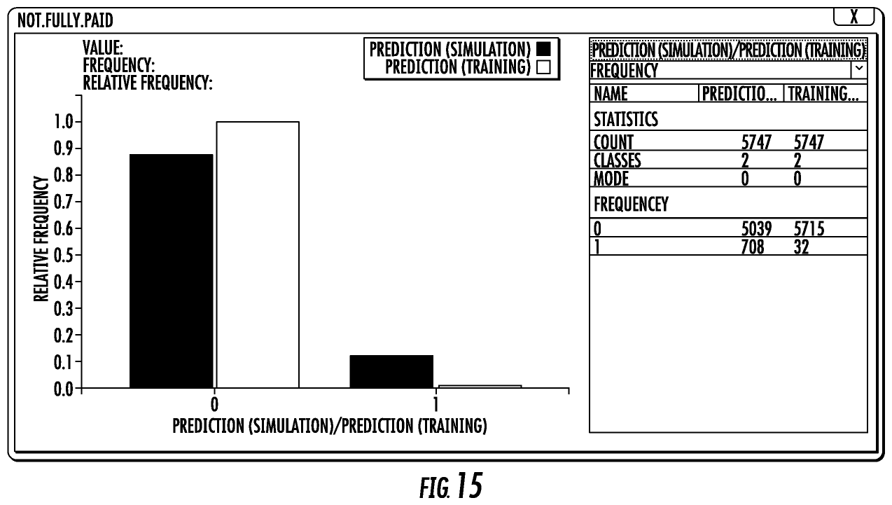

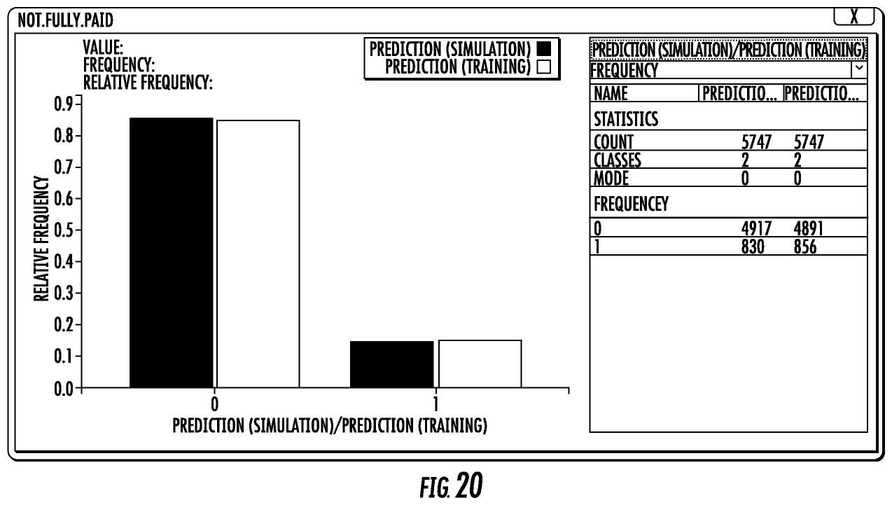

In FIG. 11, FIG. 15 and FIG. 20 (where risk analyses of different ML models are presented), an x-axis value of “0” corresponds to a prediction of no loan default, and an x-axis value of “1” corresponds to a prediction of a loan default. The y-axis represents frequencies of predictions. The left-most histogram bars in each pair of bars correspond to the synthetic (“Simulation”) dataset, and the right-most histogram bars in each pair of bars correspond to the known (“Training”) dataset. Actual counts are shown to the right of the histogram under the lower “Frequency” heading with predictions generated from the synthetic dataset appearing to the left and predictions generated from the known dataset appearing to the right. In this example the user can see that, whereas on the known data the CaRT model performs well, on the synthetic data it never predicts a loan default—making it quite unsuitable for production use, and motivating an effort to find a better (less risky) model.

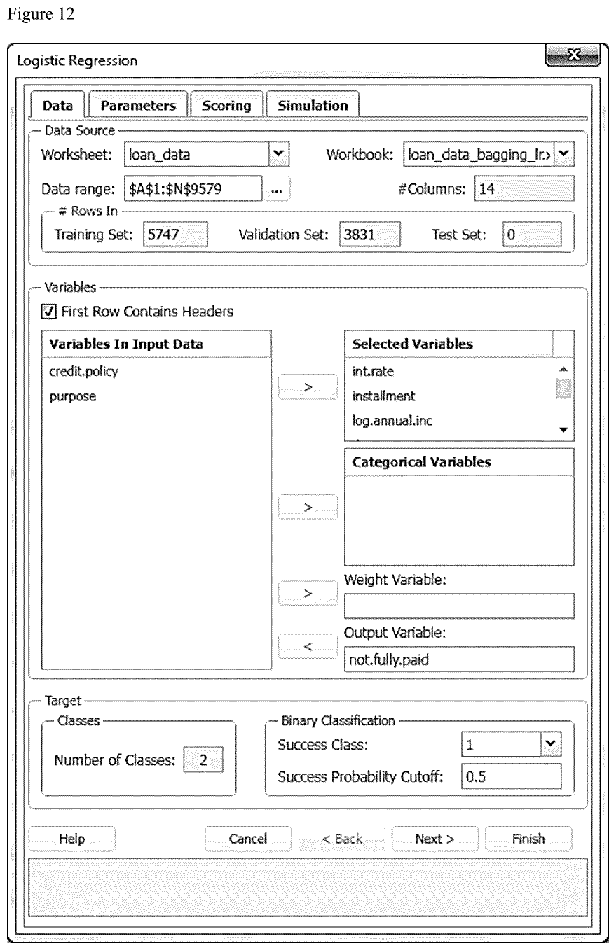

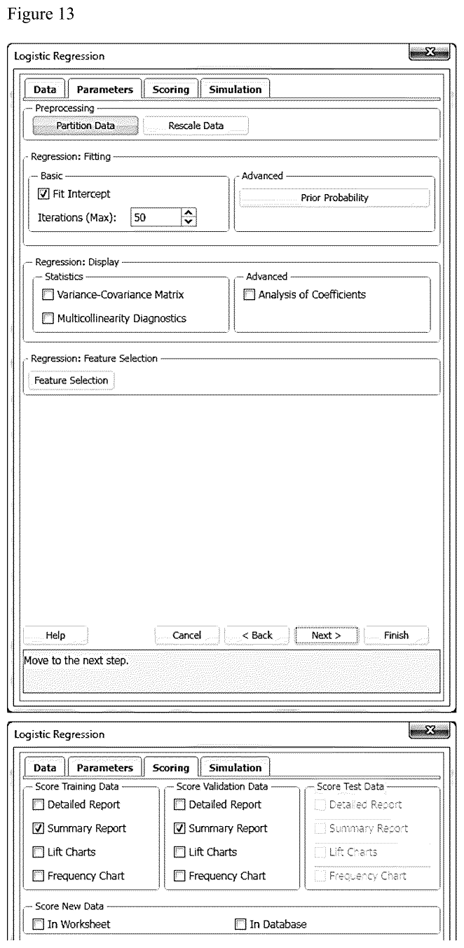

FIGS. 12, 13 and 14 teach the steps that a user carries out in Microsoft Excel, in one embodiment, to train and validate a ML model using the Logistic Regression methodology, and perform a risk analysis “on the fly” of the Logistic Regression model so trained and validated—using the Simulation tab. Since the risk analysis process is fully automated, with optional user customizations available, the only step the user must take for the risk analysis is to check the box labeled “Simulate Response Prediction”.

FIG. 15 comprises a histogram (left) and the counts used to generate the histogram (right). The histogram depicts the frequency of loan defaults (outcome “1”) predicted by a trained Logistic Regression ML model for a known (“Training”) dataset and a synthetic (“Simulation”) dataset, which allows risk analysis of the trained Logistic Regression ML model prior to production use. This comparison, in visual and numeric form, of ML model behavior on known versus simulated cases, with the ability to compare performance of different ML models on the same known versus simulated cases allows a user to assess the performance of the model on synthetic data against its performance on known data to evaluate whether the goals of the model will still be met. A histogram is one embodiment for visualization, but other embodiments will be evident to a person skilled in the art. The interpretation of the x-axis, y-axis, bar groupings and counts are the same as in FIG. 11. In this example the user can see that, whereas on the known data the Logistic Regression model predicts similar frequencies of defaults and non-defaults, on the synthetic data it predicts a much higher frequency of loan defaults—so that in production use, it might cause a lender to deny many loans that might otherwise be profitable.

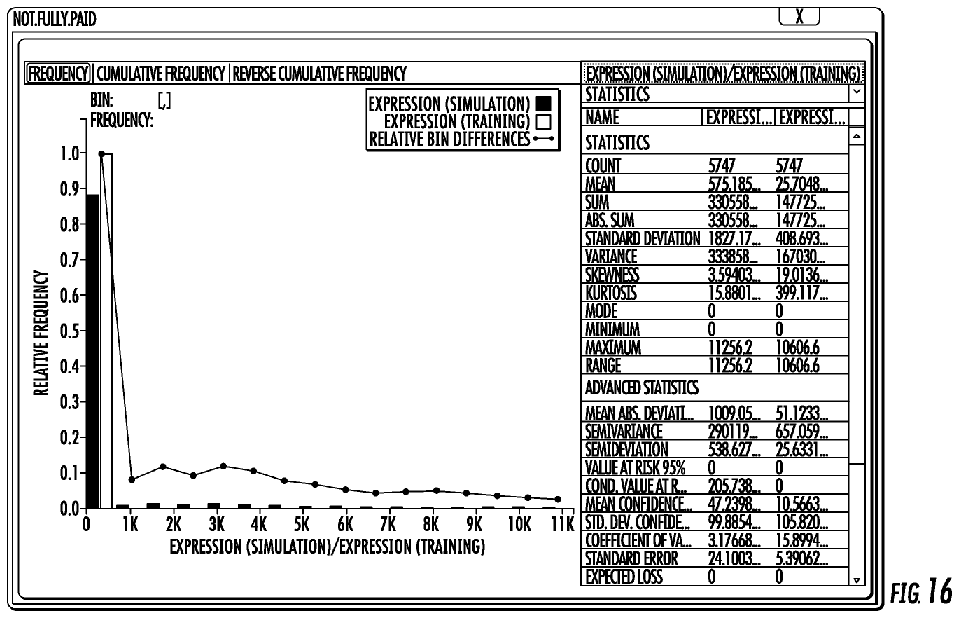

FIG. 16 comprises a histogram (left) and data and statistics related to the data presented in the histogram (right). This comparison, in visual and numeric form, focusing on financial consequences of use of a ML or other predictive model allows a user to visualize differences in outcomes or financial consequences on the synthetic data versus the known data; a histogram is one embodiment for visualization, but other embodiments will be evident to a person skilled in the art. The histogram depicts the frequency of loss by a lender on a loan by binned dollar amount of the loss, based on predictions of a trained Logistic Regression ML model on a known (“Training”) dataset and a synthetic (“Simulation”) dataset. Overlaid on the histogram is a set of points connected by straight lines, depicting relative differences between the frequency of binned predictions in the synthetic dataset versus the training dataset. This depiction, in visual and numeric form, is novel; points connected by lines are one embodiment for visualization, but other embodiments will be evident to a person skilled in the art. Also shown are statistics including the number of loans considered (“Count”), the average loss in dollars (“Mean”), the standard deviation of loss in dollars (“Standard Deviation”), the greatest loss in dollars (“Maximum”), and the range of losses in dollars (“Range”). The left-most histogram bars in each pair and the left-most data and statistics correspond to the synthetic (“Simulation”) dataset, and the right-most histogram bars in each pair and the right-most data and statistics correspond to the known (“Training”) dataset.

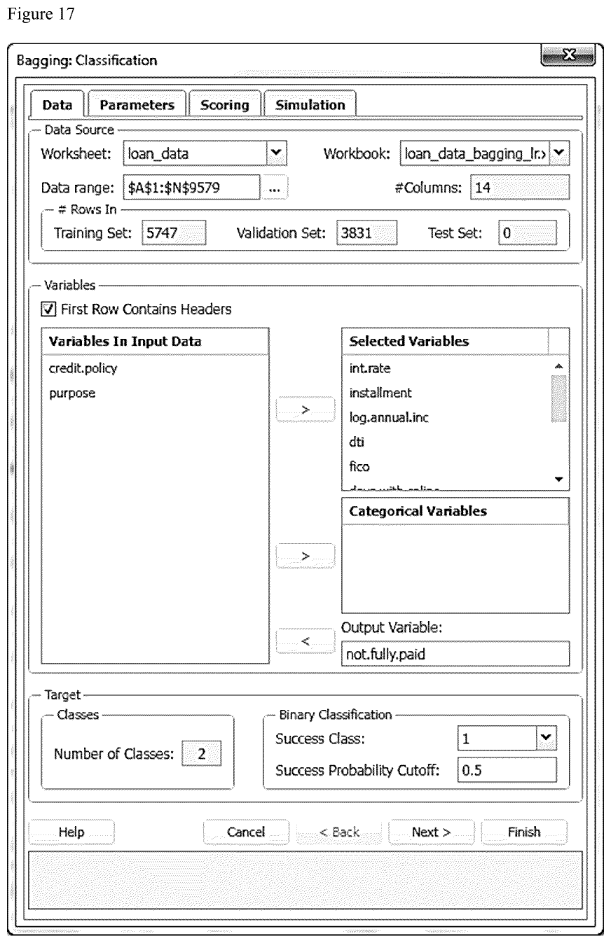

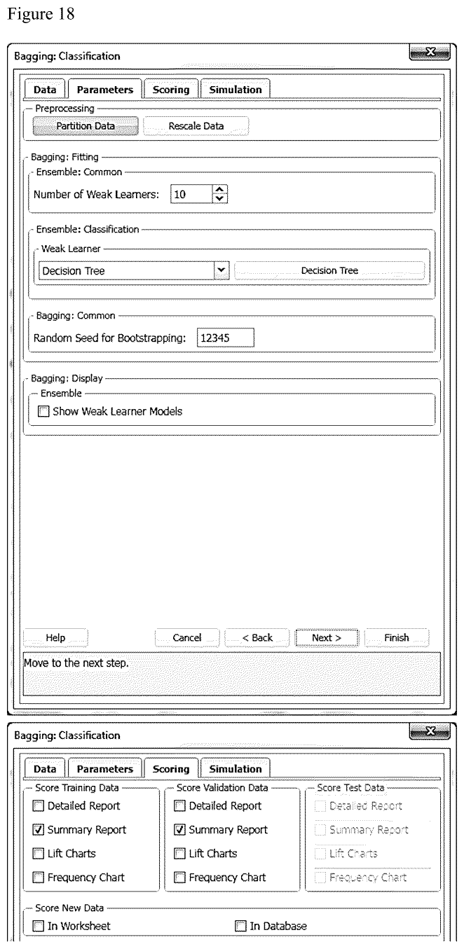

FIGS. 17, 18 and 19 teach the steps that a user carries out in Microsoft Excel, in one embodiment, to train and validate an ensemble of ML models whose predictions are combined using the Bagging methodology, and perform a risk analysis “on the fly” of the Ensemble —Bagging model so trained and validated—using the Simulation tab. Since the risk analysis process is fully automated, with optional user customizations available, the only step the user must take for the risk analysis is to check the box labeled “Simulate Response Prediction”.

FIG. 20 comprises a histogram (left) and the counts used to generate the histogram (right). The histogram depicts the frequency of loan defaults predicted by a trained ensemble of CaRT models whose predictions are combined via the Bagging methodology for a known (“Training”) dataset and a synthetic (“Simulation”) dataset, which allows risk analysis of the trained Bagging ML model prior to production use. As in FIG. 15, this comparison, in visual and numeric form, of ML model behavior on known versus simulated cases, with the ability to compare performance of different ML models on the same known versus simulated cases allows the synthetic performance to be assessed relative to the known performance to assess the risk that the ML model, when deployed for production use, will not achieve its intended goals. A histogram is one embodiment for visualization, but other embodiments will be evident to a person skilled in the art. The interpretation of the x-axis, y-axis, bar groupings and counts are the same as in FIG. 11. In this example the user can see that the ensemble of models combined by Bagging predicts similar frequencies of defaults and non-defaults on both the known data and the synthetic data—affording greater confidence that the model will perform as expected in production use.

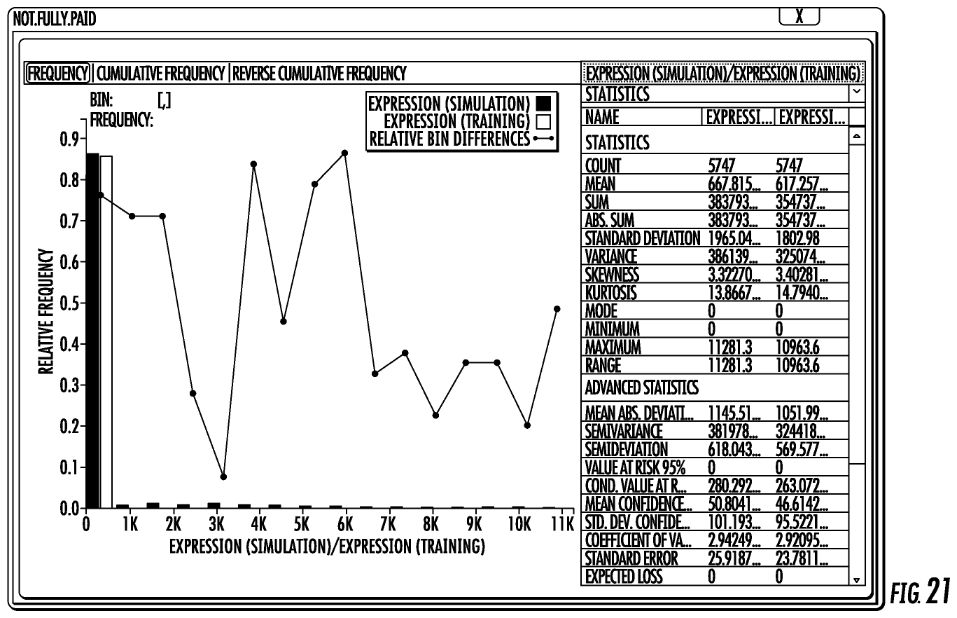

FIG. 21 comprises a histogram (left) and data and statistics related to the data presented in the histogram (right). As in FIG. 6, this comparison, in visual and numeric form, focusing on financial consequences of use of a ML or other predictive model allows the user to visualize differences in outcomes or financial consequences on the synthetic data versus the known data. A histogram is one embodiment for visualization, but other embodiments will be evident to a person skilled in the art. The histogram depicts the frequency of loss by a lender on a loan by binned dollar amount of the loss, based on predictions of a trained Bagging ML model on a known (“Training”) dataset and a synthetic (“Simulation”) dataset. As in FIG. 6, overlaid on the histogram is a set of points connected by straight lines, depicting relative differences between the frequency of binned predictions in the synthetic dataset versus the training dataset. This depiction, in visual and numeric form, is novel; points connected by lines are one embodiment for visualization, but other embodiments will be evident to a person skilled in the art. Also shown are statistics including the number of loans considered (“Count”), the average loss in dollars (“Mean”), the standard deviation of loss in dollars (“Standard Deviation”), the greatest loss in dollars (“Maximum”), and the range of losses in dollars (“Range”). The left-most histogram bars in each pair and the left-most data and statistics correspond to the synthetic (“Simulation”) dataset, and the right-most histogram bars in each pair and the right-most data and statistics correspond to the known (“Training”) dataset.

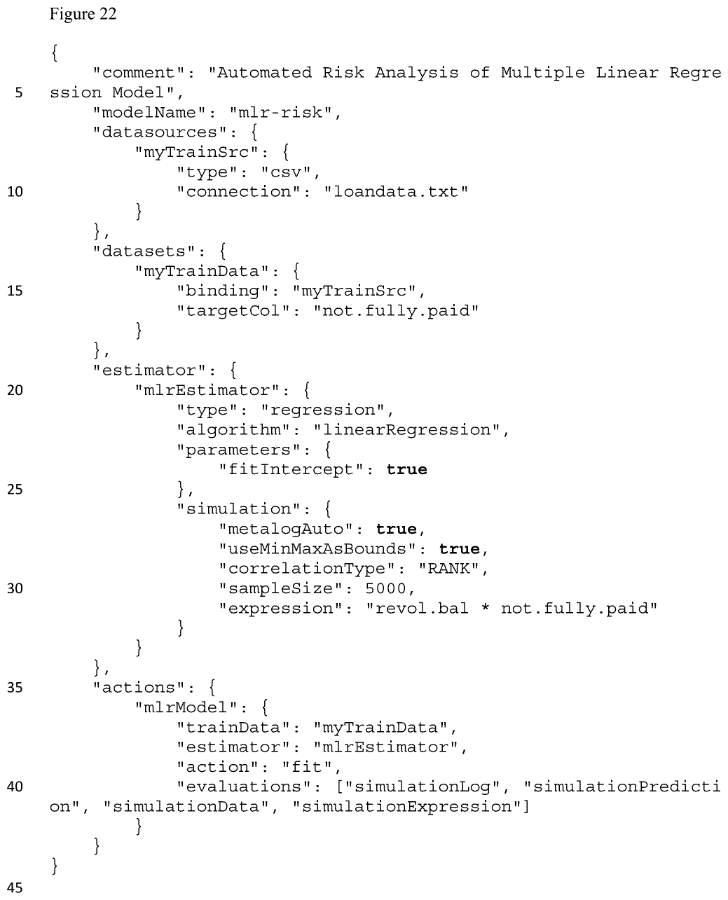

FIGS. 22 through 31 (RASON® Modeling Language Embodiment) depict a further embodiment of this specification, in which user selections for risk analysis of a regression model, fitted to the same loan dataset used in the Exemplification, are expressed in the notation of the inventors' high level modeling language RASON, and used through an ordinary web browser connected to a powerful cloud-based computing service, to generate results in JSON (JavaScript Object Notation) and in OData, forms widely used in Web and mobile rapid application development systems.

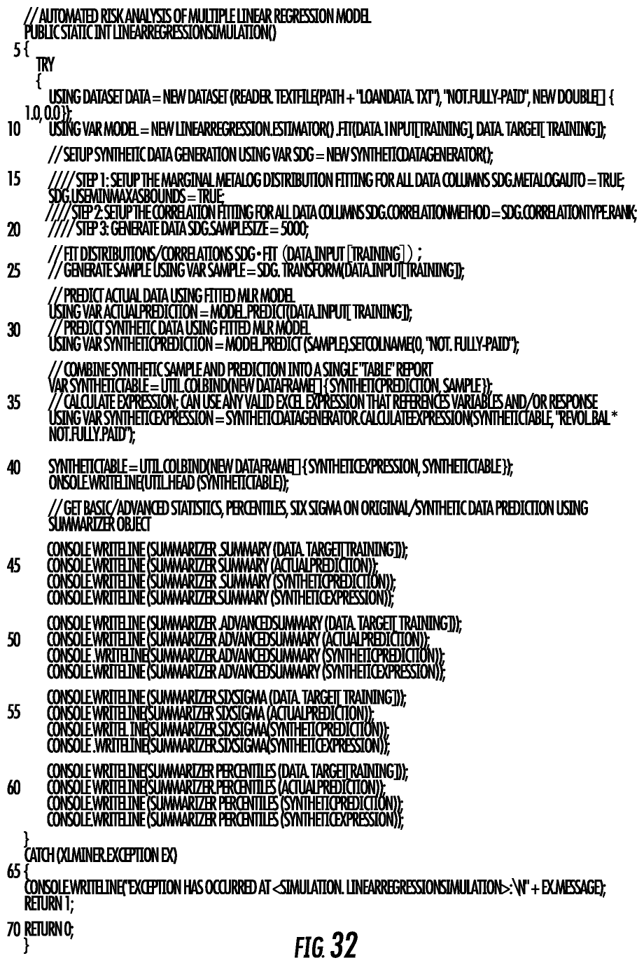

FIGS. 32 through 34 (Solver SDK® Programming Language Embodiment—C# Example) depict a further embodiment of this specification, in which user selections for risk analysis of a regression model, fitted to the same loan dataset used in the Exemplification, are expressed in the notation of the widely used C# programming language created by Microsoft, making use of a Solver SDK (Software Development Kit) library for machine learning and risk analysis computations as developed for the present embodiments.

Various aspects of this disclosure relate to systems and methods to perform risk analysis on predictive models to provide assessments of the predictive models, in which the risk analysis is performed using a synthetic dataset compared to a known dataset. The risk analysis can be advantageously automated. A predictive model is typically a ML model, but the nature of the predictive model is not limiting. When the predictive model is a ML model, then the ML model is typically a trained ML model. The risk assessment typically comprises one or more quantitative and/or statistical assessments. A risk assessment generally includes information related to risks of the production use of the predictive model. The risk analysis may be advantageously performed prior to production use of the predictive model, for example, either to determine that the predictive model is suitable for production use, or to inform selection of a specific model from a set of models trained on the same known data. An assessment may include multiple steps and elements, for example, information related to the uncertainty of predictions of the predictive model; the uncertainty of one or more outcomes that result from decisions made based partially or wholly on the predictions, which one or more outcomes may include financial, health, or other quantitative outcomes; differences between predictions of known cases and synthetic cases; and differences between one or more outcomes of known cases and one or more outcomes of synthetic cases. The use of synthetic data advantageously allows increased sampling over the full range of predictions.

The term “result” is sometimes used to refer to a decision recommended in light of a prediction made by a predictive model unless context indicates otherwise. A result is optionally different from an output or prediction of a predictive model, for example, because a result may be based on the binning of the output or prediction using threshold criteria, which is optionally variable independent of a predictive model. A predictive model may predict a probability of default on a loan, for example, and the result may be a decision to offer the loan, which is variable based on factors beyond probability of default including appetite for risk and opportunity cost.

In contrast with “result”, the term “outcome” refers to the downstream effect of the implementation of a predictive model unless context indicates otherwise. An outcome may be either a single outcome for an individual case or an aggregate outcome for multiple cases. Outcomes include, for example, expected profit for an individual case or for multiple cases.

The performance or behavior of a model refers to how the model acts statistically overall, that is, across the collective set of cases (known or synthetic), in particular with regard to achieving the goals, aims and objectives of the model for a business or enterprise.

The risk analysis method can advantageously be automated, for example, such that the method may be performed on a conventional computer system such as a personal computer system (“PC”) of an end user, who is not necessarily a technician, machine learning expert, other computer expert, or risk analysis expert. The risk analysis method does not require a custom model of the type designed by a human analyst, and the method does not require hypotheses about (a) processes that underly the predictive model, (b) the selection and evaluation of probability distributions or correlation methods, or (c) manual assessment of potentially redundant inputs to the predictive model. In contrast with the risk analysis methods of the prior art, the present entire risk analysis method can be performed “on the fly”, often in mere seconds. The risk analysis method can therefore be performed, for example, in parallel or in combination with training or validating an ML model (and any permutation of the foregoing).

The risk analysis methods of this specification typically feature a combination of steps set forth below. The combination and ordering of the steps allow risk analysis of predictive models for production use and high-speed automation. The steps are set forth for illustrative purposes only and are not intended to limit the scope of this disclosure. The skilled person will recognize that the steps may be altered in many different ways to arrive at other risk analysis methods that fall within the scope of this disclosure. The following steps describe automated processes, for example, and the skilled person will recognize that one or more of the automated processes may be performed manually to arrive at an effective risk analysis method that otherwise falls within the scope of this disclosure.

Commercial embodiments of this disclosure will generally automate all computer-assisted steps. The term “automated” and derivatives thereof encompass both full automation, for example, in which one or more computer systems perform an automated process without user input, and semi-automation, for example, in which a user provides input to an otherwise automated process.

Automated Processes of Risk Analysis of Predictive Models Using Synthetic Data Generation
An automated process performs an analysis of a dataset, composed of individual cases (sometime called datapoints) where each case is a set of input values (commonly called features or independent variables).
The cases include complete sets of input values that comprise the features.
The cases optionally include partial sets of input values that comprise less than all of the features.
The cases include in addition to the features an output value, and optionally include information that is irrelevant to a predictive model, examples of which include serial numbers.
The features are optionally based on physical real-world data, economic data, behavioral data or survey data.
The nature of the cases of a dataset is typically dependent upon the predictive model to be assessed; a case may be associated with a person, for example, and the features of a case may be features of the person such as the financial measures set forth in Table 1 below and/or health features that include by way of example age and blood pressure.
An automated process statistically assesses a known dataset by fitting a plurality of the features of a plurality of the known cases to probability distributions.
The plurality of features may consist of all of the features, but the plurality of features may optionally consist of less than all of the features; a user may deselect certain features from an analysis, for example, in a semi-automated process.
The plurality of cases may consist of all of the cases, but the plurality of cases may optionally consist of less than all of the cases.
The probability distributions for each feature optionally comprise at least one bounded Metalog probability distribution, semi-bounded Metalog probability distribution, or unbounded Metalog probability distribution.
An automated process evaluates the fits of the probability distributions to the plurality of features and selects a best-fit probability distribution for each individual feature of the plurality of features.
A best-fit probability distribution is determined by the automated process using one or a plurality of statistical criteria, such as Anderson-Darling, Kolmogorov-Smirnov, Chi-Squared, Maximum Likelihood, AIC, AICc or BIC.
An automated process optionally identifies correlations among features.
Correlations among features are optionally identified using one or both of rank correlation matrices and copulas, which optionally include one or more of Clayton, Frank, Gumbel, Gaussian and Student's T copulas.
An automated process generates a synthetic dataset that comprises synthetic cases that comprise synthetic features that are consistent with the best-fit probability distributions.
When correlations are identified, then the synthetic dataset is optionally generated such that the synthetic features are consistent with the correlations.
The synthetic dataset is optionally generated using a random or pseudorandom number generator and Monte Carlo sampling or stratified (e.g. Latin Hypercube) sampling, or Sobol number generation.
The automated process of generating a synthetic dataset from a known dataset for use in risk analysis statistically assesses the known dataset and produces a synthetic dataset that has statistical characteristics that are similar to the statistical characteristics of the known dataset. It could therefore be expected that when the predictive model is applied to the synthetic dataset, it will produce predictions and outcomes having a similar distribution to the distribution of predictions and outcomes when the predictive model is applied to the known dataset. The risk analysis reveals and quantifies the frequency and magnitude of differences in the model's behavior on the synthetic versus the known dataset.
An automated process generates predictions using a predictive model, wherein each prediction is generated by inputting a plurality of synthetic features of a synthetic case into the predictive model, and computing an output value as specified by the model.
The automated process optionally generates outcomes that flow from the output values computed by the predictive model, input feature values, and fixed external values.
An automated process generates assessments for a plurality of the predictions, and optionally for a plurality of the results, and optionally for a plurality of the outcomes.
The plurality of the predictions may consist of all of the predictions, but the plurality of predictions may optionally consist of less than all of the predictions.
The plurality of the results may consist of all of the results, but the plurality of results may optionally consist of less than all of the results.
The plurality of the outcomes may consist of all of the outcomes, but the plurality of outcomes may optionally consist of less than all of the outcomes.
An automated process constructs frequency distributions for predictions, and optionally results, and optionally outcomes.
The predictions, results, and outcomes that flow from production use of a predictive model cannot be known with certainty, and frequency distributions produced from the synthetic dataset provide information to assess the uncertainty of production use.
An automated process quantifies differences in predictions of known and synthetic cases, and optionally results, and optionally outcomes.
Some predictive models excel in predicting known datasets, such as datasets upon which an ML model is trained, and fail at predicting future datasets; quantifying differences between known and synthetic datasets allows a decision maker to assess whether a predictive model will perform as desired during production use, for example, by identifying whether the predictive model will predict a frequency distribution of results for a synthetic dataset that is comparable to a frequency distribution of results for a known dataset, such as a dataset upon which an ML model was trained.
An automated process computes one or more statistical measures for the predictions, and optionally the results, and optionally the outcomes.
Comparisons of differences in statistical measures between predictions based on a known dataset relative to predictions based on a synthetic dataset are made.
Differences may include one or more of differences in the frequencies of prediction values or binned prediction values; differences between average prediction values; differences between ranges of prediction values; and differences between standard deviations of prediction values.
An automated process creates one or more figures such as charts, graphs, and the like that display statistics related to the predictions and optionally the results and optionally the outcomes.

Each prediction of the plurality of the predictions is optionally associated with one of several classes, and the assessments optionally comprise one or more of (1) numerical values that are the integer counts of the classes; (2) in the case of only two classes, one or both numerical values that are frequencies of the two classes relative to the other of the two classes such as ratios, decimals, or fractions; (3) numerical values that are frequencies of each class relative to all of the classes such as ratios, decimals, fractions, or percentages; and (4) one or more figures, such as a histogram, pie chart, line graph, or the like, which graphically display one or more of the preceding numerical values.

Each prediction of the plurality of the predictions is optionally associated with a continuous value, and the assessments optionally comprise one or more of (1) one or more statistics calculated using the continuous values such as an average, median, mode, or standard deviation; (2) one or more numerical values that are the integer counts of binned continuous values, in which generating the assessments comprises binning the continuous values based on binning criteria such as numerical boundaries; (3) one or more numerical values that are frequencies of one or more binned continuous values relative to frequencies of one or more other binned continuous values such as ratios, decimals, or fractions, in which generating the assessments comprises binning the continuous values based on binning criteria such as numerical boundaries; (4) one or more numerical values that are frequencies of one or more binned continuous values relative to all of the continuous values such as ratios, decimals, fractions, or percentages, in which generating the assessments comprises binning the continuous values based on binning criteria such as numerical boundaries; (5) one or more numerical values that correspond to the magnitude of an expected outcome; and (6) one or more figures, such as a histogram, pie chart, line graph, or the like, which graphically display one or more of the preceding numerical values or the mathematical distribution function.

A class or categorical value may be one of a small set of values, for example, health decisions such as a decision to provide one of several treatments to a patient, or financial decisions such as a decision to approve, or not approve a loan; assessments of categorical values may be used, for example to assess a volume of activity that a predictive model is likely to generate such as a volume of medical patients receiving different treatments or a volume of approved loans.

A continuous value may be a numerical prediction, for example, the blood level of an antigen associated with cancer or a composite credit score summarizing a loan applicant's creditworthiness; assessments of continuous predictions may be used, for example, to assess whether a patient should be treated for cancer or whether a loan should be offered.

A continuous value may be a numerical result, which is a decision based on a prediction that includes, for example, health decisions such as the dose of a drug or amount of radiation treatment to provide to a cancer patient, or financial decisions such as an amount authorized for a loan; assessments of continuous value results may be used, for example, to assess the resources that a predictive model is likely to demand such as an amount of a chemotherapeutic agent or an amount of money to loan across patients or loan applicants in the aggregate.

A continuous value may be a numerical outcome that follows a decision based on a prediction, and which includes, for example, health outcomes such as length of survival and financial outcomes such as financial amount of a default on a loan; assessments of continuous value outcomes may be used, for example, to assess an expected increase in life expectancy attributable to decisions made pursuant to the predictive model or the expected profitability of decisions made pursuant to the predictive model in the aggregate.

In some embodiments, the automated processes are configured to be performed in time that is a small fraction of the total time required to train and validate a machine learning model on the same dataset, which advantageously enables the automated process to be performed whenever such training and validation is performed. In some embodiments, the automated processes are configured to be performed in no greater than ten minutes on a standard computer system. In some specific embodiments, the automated processes are configured to be performed in no greater than one minute on a standard computer system. In some very specific embodiments, where the dataset consists of fewer than tens of thousands of cases, the automated processes are configured to be performed in a matter of tens of seconds on a standard computer system. The speed at which risk analysis assessments are created based on predictive models and the time necessary to create such risk analysis assessments are result-effective variables.

The term “standard computer system” refers to (i) a computer configured with at least the minimum hardware requirements to run Microsoft® Windows® software, or (ii) a virtual machine or cloud service running on Microsoft® Azure® or Amazon AWS®, configured to display results through a web browser on a wide range of Internet-connected devices, as well as computers configured with comparable hardware that are incapable of running such versions of Windows®, Azure® or AWS® because of compatibility issues.

Various aspects of the disclosure relate to a computer system configured to perform a method described in this disclosure such as one or more automated process steps. Such computer systems generally store software configured to perform one or more automated process steps of the disclosure. A computer system may also be configured to perform one or more automated process steps using software stored on a remote computer such as a computer server.

In some embodiments, the method is configured to be performed using software. In some specific embodiments, the method is configured to be performed using a graphical user interface. In some very specific embodiments, the method is configured to be performed using a graphical user interface of spreadsheet software. The software may be, for example, Microsoft® Excel®, but the precise nature of the software is not limiting. The software may be, for example, “visual business intelligence and analytics” software, “notebook” display software, web browser, tablet or smartphone “app” software, coding software, database software, or other software licensed by Microsoft® or any other vendor or no vendor at all, such as custom software. The inventors have implemented methods of the disclosure, for example, in Frontline Solvers® Analytic Solver®, Solver SDK® and RASON® software for use in Microsoft® products including Excel®, Visual Studio®, and Azure®.

The automated process can be advantageously automated to select probability distributions within the Metalog family of probability distributions. In some embodiments, fitting a plurality of the features of a plurality of the cases to probability distributions consists of fitting the plurality of features to Metalog probability distributions. In some embodiments, each best-fit probability distribution is a Metalog probability distribution.

Various aspects of this specification relate to a method to perform risk analysis on a predictive model using a synthetic dataset. The method may be an automated method. The predictive model may be, for example, a ML model such as a trained ML model. A trained ML model may have been trained, for example, on a portion or all of a known dataset.

In some embodiments, the method comprises providing a known dataset that comprises known cases. The known dataset may be provided, for example, in a spreadsheet, a comma-separated-value (CSV) file, or a relational table in a SQL database. An examples of a dataset provided in a spreadsheet is depicted in FIG. 2.

In some embodiments, the known dataset is organized as rows such that some or all of the rows correspond to different known cases; each row is subdivided into cells; each cell optionally comprises a value for a known feature of a known case such that each known case comprises at least one known feature; and the known dataset is organized such that known features of the same type are organized into columns that span more than one row. The known dataset may optionally comprise one or more rows that do not correspond to a case, for example, such as one or more header rows or empty rows. A column may optionally lack a feature for any given row, for example, when a given row does not correspond to a case or when a case lacks the feature.

A row that corresponds to a case may also comprise one or more cells that comprise one or more results; in such instances, the dataset is generally organized such that results of the same type are organized in columns that span more than one row.

A row that corresponds to a case may also comprise one or more cells that comprise one or more outcomes; in such instances, the dataset is generally organized such that outcomes of the same type are organized in columns that span more than one row.

In some embodiments, the method comprises generating a synthetic dataset by statistically assessing a known dataset. In some specific embodiments, the method comprises automatically generating a synthetic dataset based on the known dataset using a computer. A synthetic dataset is generally generated such that the synthetic dataset has statistical characteristics that are similar to or substantially consistent with the known dataset. The use of a best-fit probability distribution to generate the synthetic dataset typically provides a high degree of statistical similarity between the known dataset and the synthetic dataset. However, the interfaces of FIGS. 6 and 7, for example, allow comparison of the statistical characteristics of the known dataset and the synthetic dataset, allowing the user to reject the risk analysis if the variation is too great. The degree of similarity required of the synthetic data set versus the known data set may be configurable by the user, e.g. by selecting the particular probability distributions and altering any parameters and limits of these probability distributions.

When the known dataset is provided in a spreadsheet, CSV file or relational table, then the synthetic dataset may be generated such that it also exists in either the same or a different spreadsheet, CSV file or relational table, but the format of the synthetic dataset is not particularly limiting.

A synthetic dataset may be organized in the same manner as a known dataset. For example, in some embodiments, the synthetic dataset is organized as rows such that some or all of the rows correspond to different synthetic cases; each row is subdivided into cells; each cell optionally comprises a synthetic feature of a synthetic case such that each synthetic case comprises at least one synthetic feature; and the synthetic dataset is organized such that synthetic features of the same type are organized into columns that span more than one row. The synthetic dataset may optionally comprise one or more rows that do not correspond to a synthetic case, for example, such as one or more header rows or empty rows. A column may optionally lack a synthetic feature for any given row, for example, when a given row does not correspond to a synthetic case. A synthetic case generally includes all of the features that other synthetic cases include, but this relationship is unrequired, the relationship is not particularly limiting, and the relationship might be disfavored in some instances, for example, to better approximate the real-world conditions of production use.

A row that corresponds to a synthetic case may also comprise one or more cells that comprise one or more synthetic results; and in such instances, the dataset is generally organized such that synthetic results of the same type are organized in columns that span more than one row.

A row that corresponds to a case may also comprise one or more cells that comprise one or more outcomes; and in such instances, the dataset is generally organized such that outcomes of the same type are organized in columns that span more than one row.

In some embodiments, the method comprises providing the predictive model such as a trained ML model.

In some embodiments, the method comprises calculating predictions using the predictive model based on the synthetic dataset. In some specific embodiments, the method comprises automatically calculating predictions using the predictive model based on the synthetic dataset using a computing device, such as a computer, tablet or smartphone.

In some embodiments, the method comprises calculating statistics selected from a count, frequency, average, median, mode, range, or standard deviation of prediction values predicted from a known dataset and from a synthetic dataset and comparing the statistics. In some specific embodiments, the method comprises calculating statistics selected from a count, frequency, average, median, mode, range, or standard deviation of prediction values predicted from a known dataset and from a synthetic dataset and comparing the statistics using a computing device. In some very specific embodiments, the method comprises calculating statistics selected from a count, frequency, average, median, mode, range, or standard deviation of prediction values predicted from a known dataset and from a synthetic dataset and comparing the statistics using spreadsheet software on a computer.

In some embodiments, the method comprises displaying to a user a comparison of different counts, frequencies, averages, medians, modes, ranges, or standard deviations of prediction values predicted from a known dataset and from a synthetic dataset. In some specific embodiments, the method comprises displaying to a user a comparison of different counts, frequencies, averages, medians, modes, ranges, or standard deviations of prediction values predicted from a known dataset and from a synthetic dataset on a computer, tablet or smartphone screen. In some very specific embodiments, the method comprises displaying to a user a comparison of different counts, frequencies, averages, medians, modes, ranges, or standard deviations of prediction values predicted from a known dataset and from a synthetic dataset on a computer, tablet or smartphone screen using spreadsheet software. Displaying may comprise one or more of displaying either numbers that allow for the comparison or one or more graphs such as one or more histograms.

EXEMPLIFICATION. Risk analysis of ML Models configured to predict loan defaults.

This example illustrates a use of the methods of the disclosure to assess the uncertainty and risk of a ML model. The ML model is trained and validated on a known dataset of 9,578 known cases of loan applicants who received loans and either timely repaid the loans or defaulted. The known dataset is presented in a spreadsheet in Microsoft Excel, a portion of which is shown in FIG. 2.

Features and outcomes of the known dataset are set forth in Table 1. The known cases lack predictions because predictions are dependent upon a predictive model. A loan was funded for each known case, and thus, the result is the same for each known case. Each case includes a value 1 or 0 (denoted “outcome” in this dataset, but distinct from a full outcome or financial consequence to a lender) on whether an applicant defaulted or fully repaid a loan.

TABLE 1
Descriptions of the Features and Outcomes
of Cases for a Known Dataset

| Column | Type of Feature | Description of Feature |
|---|---|---|
| A | credit.policy | The feature is either 1 if the |
| | | customer meets the credit |
| | | underwriting criteria of |
| | | LendingClub.com, and 0 |
| | | otherwise. |
| B | purpose | The feature is “creditcard”, |
| | | “debtconsolidation”, |
| | | “educational”, |
| | | “majorpurchase”, |
| | | “smallbusiness”, or |
| | | “all_other”. |
| C | int.rate | The feature is the interest rate |
| | | of the loan. |
| D | installment | The feature is the monthly |
| | | installments owed by the |
| | | borrower. |
| E | log.annual.inc | The feature is the natural log |
| | | of the self-reported annual |
| | | income of the borrower. |
| F | dti | The feature is the debt-to- |
| | | income ratio of the borrower |
| | | (amount of debt divided by |
| | | annual income). |
| G | fico | The feature is the FICO credit |
| | | score of the borrower. |
| H | days.with.cr.line | The feature is the number of |
| | | days the borrower has had a |
| | | credit line. |
| I | revol.bal | The feature is the borrower's |
| | | revolving balance. |
| J | revol.util | The feature is the borrower's |
| | | revolving line utilization rate. |
| K | inq.last.6mths | The feature is the borrower's |
| | | number of inquiries by |
| | | creditors in the last six |
| | | months. |
| L | delinq.2yrs | The feature is the number of |
| | | times the borrower had been |
| | | 30+ days past due on a |
| | | payment in the past 2 years. |
| M | pub.rec | The feature is the borrower's |
| | | number of derogatory public |
| | | records (bankruptcy filings, |
| | | tax liens, or judgments). |
| Column | Type of Outcome | Description of Possible Outcomes |
| N | not.fully.paid | The outcome is 1 if the |
| | | borrower defaulted and did not |
| | | fully pay off the loan, and 0 if |
| | | the borrower fully paid off the |
| | | loan. |

As noted above, FIGS. 3, 4 and 5 teach the steps that a user carries out in Microsoft Excel, using the inventors' software Analytic Solver® for Excel, to perform the subset of the risk analysis process that uses synthetic data generation (SDG). This SDG process is carried out automatically and “silently” as part of risk analysis during the training of a ML model; it may also be used by itself, so it is detailed once, and user options are shown in these figures.

Based on the user's selections in FIGS. 3, 4 and 5, the automated processes of the disclosure are used to generate a synthetic dataset of 5,747 different synthetic cases that are consistent with the known dataset, including the four points below.
An automated process first performs an analysis of the dataset, which allows the parsing of features from outcomes as well as the omission of types of features that might not be used in the analysis such as “credit.policy”, e.g. because those features have limited predictive value for predicting loan defaults.
An automated process then fits selected features to probability distributions, evaluates the fits, and selects a best-fit probability distribution for each type of feature. The fitting and selection of probability distributions is optionally fully- or semi-automated to optionally allow users, for example, to adjust or remove lower and upper bounds of a Metalog probability distribution.
An automated process then identifies correlations between features using, for example, rank correlation matrices or copulas. The identification of correlations is optionally fully- or semi-automated to optionally allow users, for example, to choose between correlation matrices and copulas including choices of specific types of copulas such as Clayton, Frank, Gumbel, Gauss and Student copulas.
An automated process then generates a synthetic dataset of 5,747 different synthetic cases using one of Monte Carlo, Latin Hypercube sampling, and Sobol number generation. The generation of synthetic cases is optionally fully- or semi-automated to optionally allow users, for example, to choose random seeds and/or to choose between different methods of sampling.

FIG. 6 shows the visualization of binned known features (upper histogram panels), binned synthetic features (lower histogram panels), and best-fit probability distributions (overlayed lines). FIG. 7 displays the detailed chart and statistics that appear when the user double-clicks on an individual chart in the panel of charts in FIG. 6.

This synthetic data generation process is carried out automatically and “silently” as part of risk analysis conducted during the training of a ML model, as illustrated in later figures for three types of ML models: CaRT in FIGS. 8, 9 and 10; Logistic Regression in FIGS. 12, 13 and 14; and Ensemble Bagging in FIGS. 17, 18 and 19.

Classification Tree Model

FIGS. 8, 9 and 10 teach the steps that a user carries out in Microsoft Excel, using the inventors' software Analytic Solver® for Excel, to train and validate a ML model using the Classification and Regression Tree (CaRT) methodology, and perform a risk analysis “on the fly” of the CaRT model so trained and validated—using the Simulation tab.

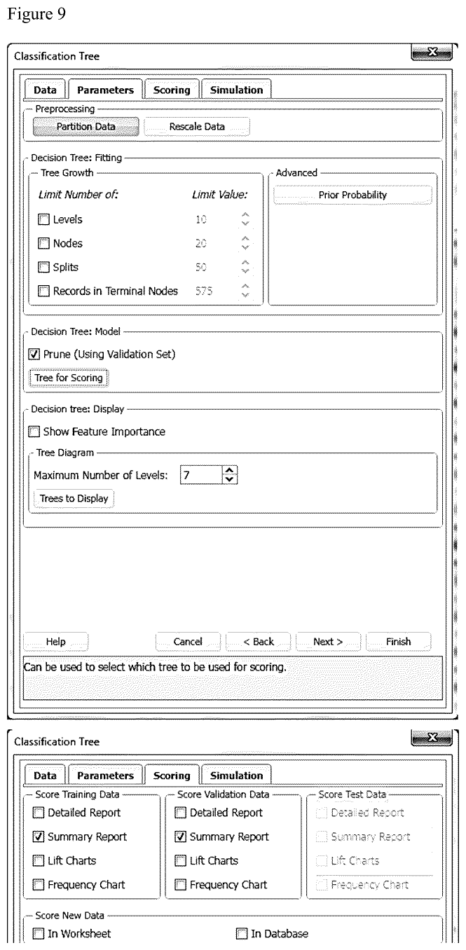

The dialogs and steps in FIGS. 8 and 9 are in prior, published versions of Analytic Solver for Excel (and similar steps are available in other software); for example, FIG. 8 shows how the user can optionally select some, but fewer than all of the features for use in the trained model, and FIG. 9 shows how the user can optionally choose to partition the known dataset into “training” and “validation” sets, and in the CaRT methodology, use the validation set to “prune” the tree.

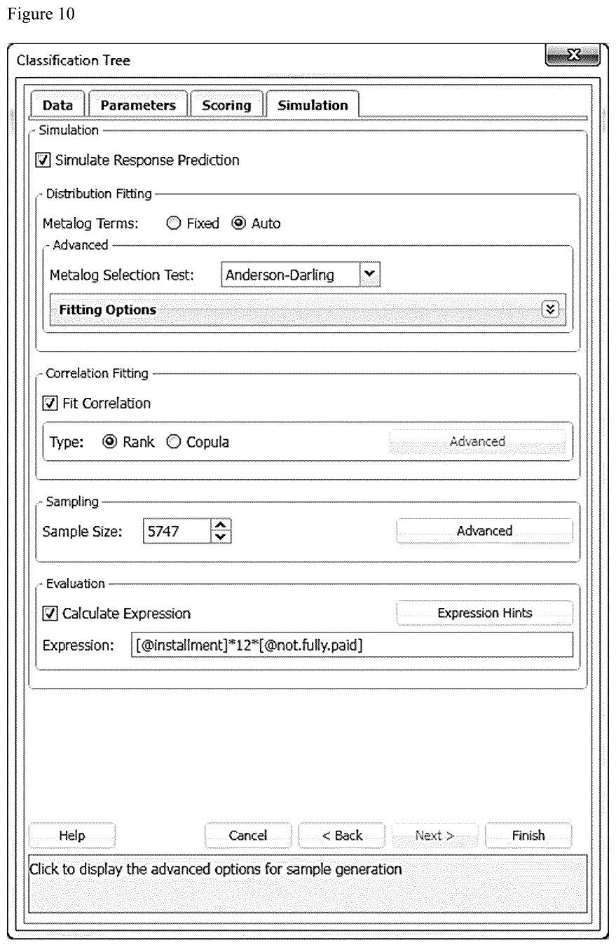

FIG. 10 teaches the steps taken by the user, in accordance with an embodiment of the present disclosure, to carry out the automated risk analysis process. Since the risk analysis process is fully automated, with optional user customizations available, the only step the user must take for the risk analysis is to check the box labeled “Simulate Response Prediction”. In this example, the user also chooses to set the Sample Size to 5,747 cases, and to define a financial outcome (using Excel's Data Table syntax) “[@installment]*12*[@not.fully.paid]”, referencing features of the loan data.

An automated process is then used to assess the performance of a predictive model by generating the synthetic dataset, generating predictions using the predictive model on the synthetic dataset and generating assessments of the predictions. FIG. 11 displays an assessment that is a histogram of an extreme result, which suggests that a trained CaRT ML model might be expected to fail in production use. This comparison, in visual and numeric form, of ML model behavior on known versus simulated cases allows a user to readily assess the risk that the model will achieve the required goals of the model in production use. The trained CaRT ML model predicts 897 defaults among 5,747 loan applications for the known dataset and 0 defaults among 5,747 loan applications for the synthetic dataset. That is, the statistical default rate from the synthetic dataset is substantially varied from the statistical default rate of the known dataset, despite the known dataset and the synthetic dataset having similar statistical characteristics. The use of the methods of this disclosure would therefore suggest that the trained CaRT ML model is unsuitable for production use because the trained CaRT ML model is only effective at identifying defaults in the known dataset upon which it was trained. If the trained CaRT ML model were put into production use, then the trained CaRT ML model might lack any value whatsoever.

The trained CaRT ML model of the foregoing paragraph makes a prediction as to whether a default will occur, which is different from the actual decision to make a loan (which is referred to as a “result” in this disclosure), and which is different from the actual outcome of either timely repayment or default. The outcome as to whether a default will actually occur cannot be determined for any synthetic case, but a decision maker can use an aggregate assessment such as the histogram of FIG. 11 to reject the trained CaRT ML model as unsuitable for production use. An ability to make such an aggregate assessment allows a user to fully assess whether the model is likely to function adequately in production use.

Logistic Regression Model

FIGS. 12, 13 and 14 teach the steps that a user carries out in Microsoft Excel, using the inventors' software Analytic Solver® for Excel, to train and validate a ML model using the Logistic Regression methodology, and perform a risk analysis “on the fly” of the Logistic Regression model so trained and validated—using the Simulation tab.

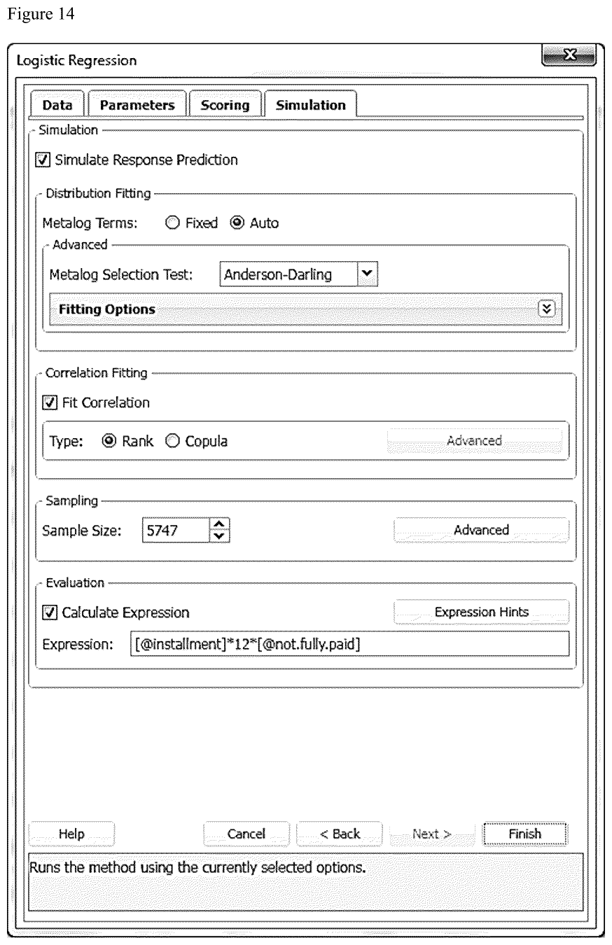

FIG. 14, like FIG. 10, teaches the steps taken by the user to carry out the automated risk analysis process in accordance with an embodiment of this specification. Since the risk analysis process is fully automated, with optional user customizations available, the only step the user must take for the risk analysis is to check the box labeled “Simulate Response Prediction”. In this example, the user also chooses to set the Sample Size to 5,747 cases, and to define a financial outcome (using Excel's Data Table syntax) “[@installment]*12*[@notfully.paid]”, referencing features of the loan data.

FIG. 15 displays an assessment that is a histogram of a different result, which suggests that a trained Logistic Regression ML model might be expected to fail in production use. This comparison, in visual and numeric form, of ML model behavior on known versus simulated cases allows a user to readily assess the risk that the model will achieve the required goals of the model in production use. The trained Logistic Regression ML model predicts 32 defaults among 5,747 loan applications for the known dataset and 708 defaults among 5,747 loan applications for the synthetic dataset. The large variation in the predicted default rates is not commensurate with the small statistical variation between the known dataset and the synthetic dataset. The use of the methods of this disclosure would therefore suggest that the trained Logistic Regression ML model is high risk and unsuitable for production use because the trained Logistic Regression ML model might recommend rejecting loan applications that present a low risk of default.

FIG. 16 displays additional assessments of the trained Logistic Regression ML Model against the known and synthetic datasets including a histogram and statistical assessments of a financial outcome, the loss amounts for loans not fully paid. This comparison, in visual and numeric form, focuses on financial consequences of use of a ML or other predictive model. The histogram shows divergent performance against the known and synthetic datasets in greater granularity than FIG. 15, highlighted by the overlay line showing relative differences across binned loan loss amounts. The statistical assessments depict an average loss of $26 for known cases versus $575 for synthetic cases and a standard deviation of $409 for known cases versus $1,827 for synthetic cases. These metrics are divergent and therefore provide an unfavorable risk analysis profile that would likely dissuade a decision maker from deploying the trained Logistic Regression ML model for production use.

Ensemble Bagging Model

FIGS. 17, 18 and 19 teach the steps that a user carries out in Microsoft Excel, using the inventors' software Analytic Solver® for Excel, to train and validate a ML model using the Ensemble—Bagging methodology, and perform a risk analysis “on the fly” of the Bagging model so trained and validated—using the Simulation tab.

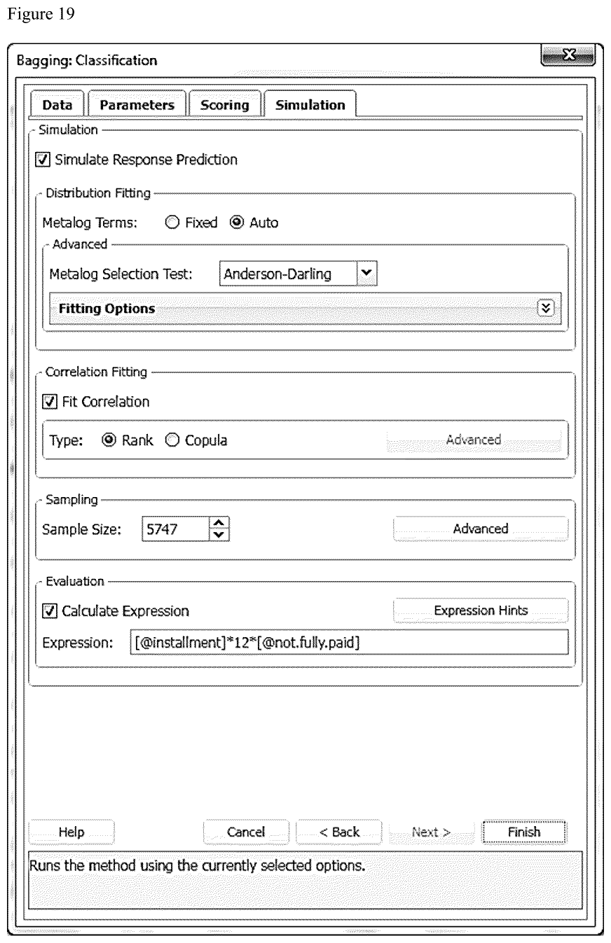

FIG. 19, like FIGS. 14 and 10, teaches the steps taken by the user to carry out the automated risk analysis process in this specification. Since the risk analysis process is fully automated, with optional user customizations available, the only step the user must take for the risk analysis is to check the box labeled “Simulate Response Prediction”. In this example, the user also chooses to set the Sample Size to 5,747 cases, and to define a financial outcome (using Excel's Data Table syntax) “[@installment]*12*[@notfully.paid]”, referencing features of the loan data. FIG. 20 displays an assessment that is a histogram of a superior result from a risk analysis perspective, in which the methods of the disclosure identify a trained Bagging ML model that appears to perform appropriately against synthetic cases. This comparison, in visual and numeric form, focuses on financial consequences of use of a ML or other predictive model. The trained Bagging ML model is based on a trained ensemble of CaRT ML models that are combined using the Bagging method. The trained Bagging ML model predicts 856 defaults among 5,747 loan applications in the known dataset and 830 defaults among 5,747 loan applications on a synthetic dataset. This statistical similarity between the predictions/outcomes of the model applied to the known and synthetic datasets commensurate with the similarity in the statistical characteristics of the datasets themselves, suggests that the trained Bagging ML model might be suitable for production use.

FIG. 21 displays additional assessments of the trained Bagging ML model against the known and synthetic datasets including a histogram and statistical assessments. The histogram shows comparable performance against the known and synthetic datasets. This comparison, in visual and numeric form, focuses on financial consequences of use of a ML or other predictive model. The statistical assessments depict an average loss of $617 for known cases versus $667 for synthetic cases and a standard deviation of $1,803 for known cases versus $1,965 for synthetic cases. These metrics are comparable and therefore provide a favorable risk analysis profile that might provide a decision maker with confidence in deploying the trained Bagging ML model for production use.

The trained Logistic Regression ML model slightly outperformed the trained Bagging ML model on the validation dataset with a correct prediction rate for default of 83.0 percent for the trained Logistic Regression ML model relative to 82.7 percent for the trained Bagging ML model. The risk analysis utilizing synthetic data set forth in this exemplification, however, suggests that the Logistic Regression ML model presents a much greater risk than the trained Bagging ML model. The automated identification of such risk was not previously available, and only the risk analysis methods set forth in this disclosure allow for the identification of such risk.

FIG. 21 displays additional assessments of the trained Bagging ML Model against the known and synthetic datasets including a histogram and statistical assessments of the same financial outcome, the loss amounts for loans not fully paid. The histogram and overlay line highlight divergent performance against the known and synthetic datasets in greater granularity than FIG. 20. This analysis, not previously available, informs a decision maker about risks of loss that may arise with loans of different sizes.

In the present example, three predictive models that produce a comparable prediction, i.e. loan default, have been compared. A risk analysis performed on each model in accordance with the present embodiments has been able to show which of these models is likely to be the least risky when applied to future datasets. By comparing the risks of comparable models, a recommendation of the most appropriate model for implementation may be made.

Web and Mobile Rapid Application Development

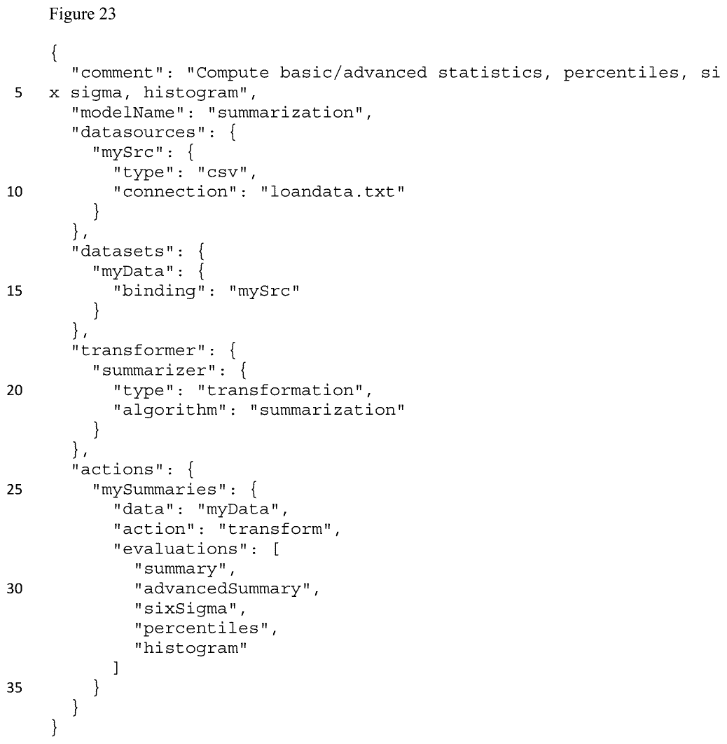

FIGS. 22 through 31 illustrate how a “citizen data scientist” (or “citizen developer”) who prefers to use Web and mobile rapid application development tools (also called “low-code/no-code tools”) can use an embodiment of this specification in the inventors' RASON® Decision Services cloud platform to request the same risk analysis and assessment illustrated in FIGS. 2 through 21 using Microsoft Excel. The references to “evaluations”: [“simulationLog”, “simulationPrediction”, “simulationData”, “simulationExpression” ] in FIG. 22, and to “evaluations”: [“summary”, “advancedSummary”, “sixSigma”, “percentiles”, “histogram” ] in FIG. 23 are used to generate the comparisons and statistics described earlier for Excel.

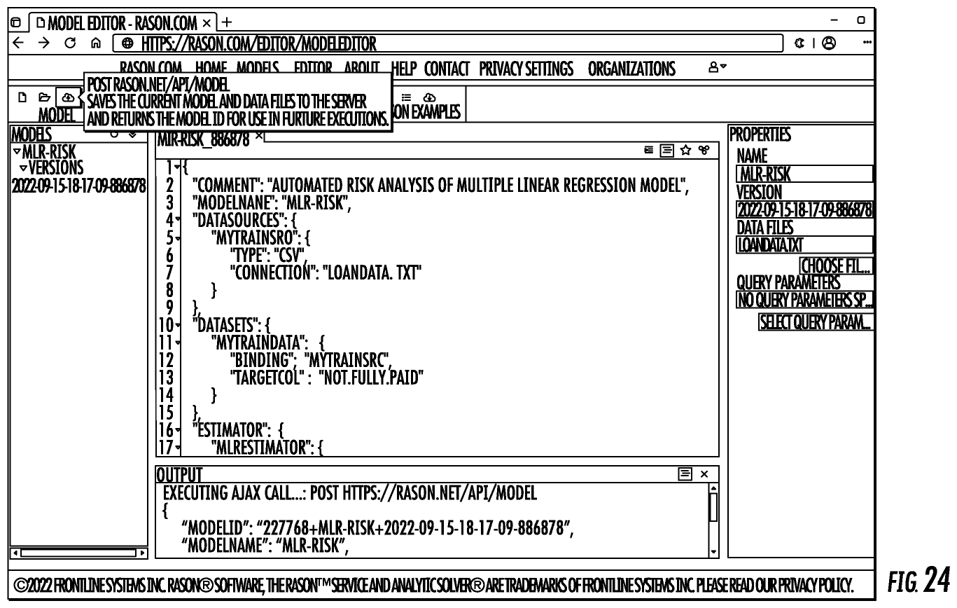

FIGS. 24 to 31, showing an ordinary web browser opened to the website Rason.com, teach the user steps to transfer the commands in FIGS. 22 and 23 to the RASON cloud service, execute the commands, and obtain risk analysis results. Since web and mobile applications typically provide their own user interfaces including charts, the RASON service simply performs the analysis and delivers the quantitative results in open-standard formats including JSON (JavaScript Object Notation) and OData that are widely accepted and easy to use in such applications.

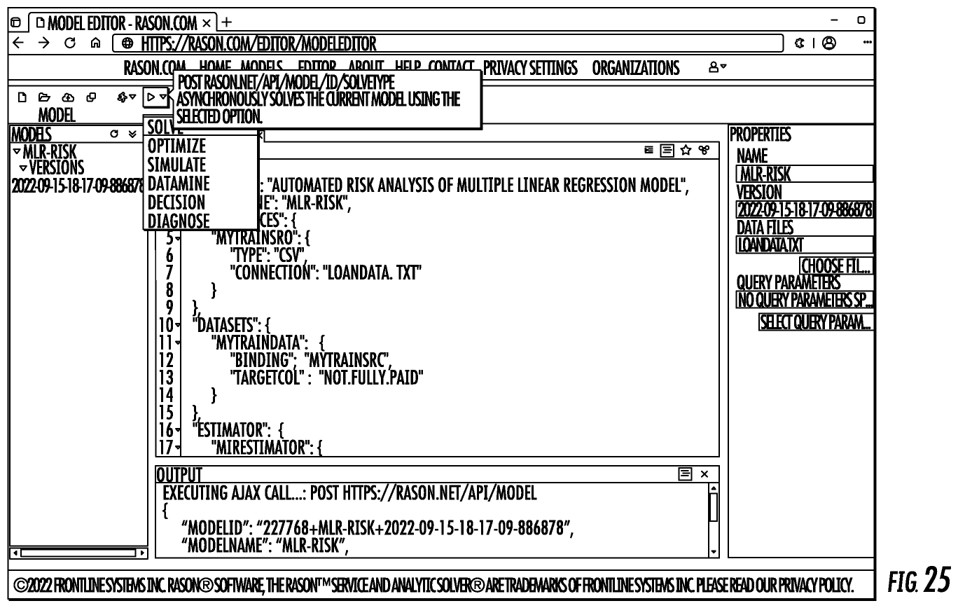

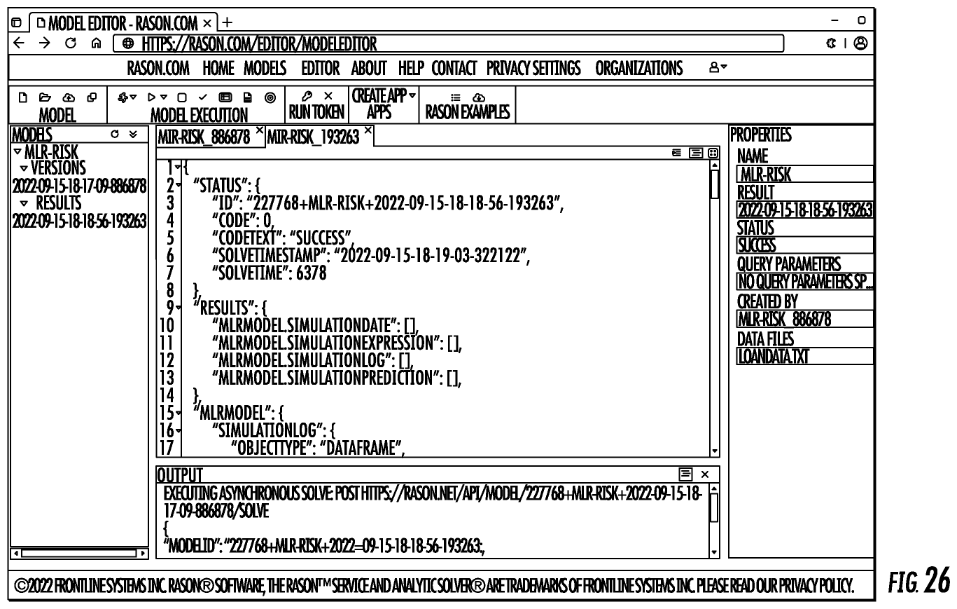

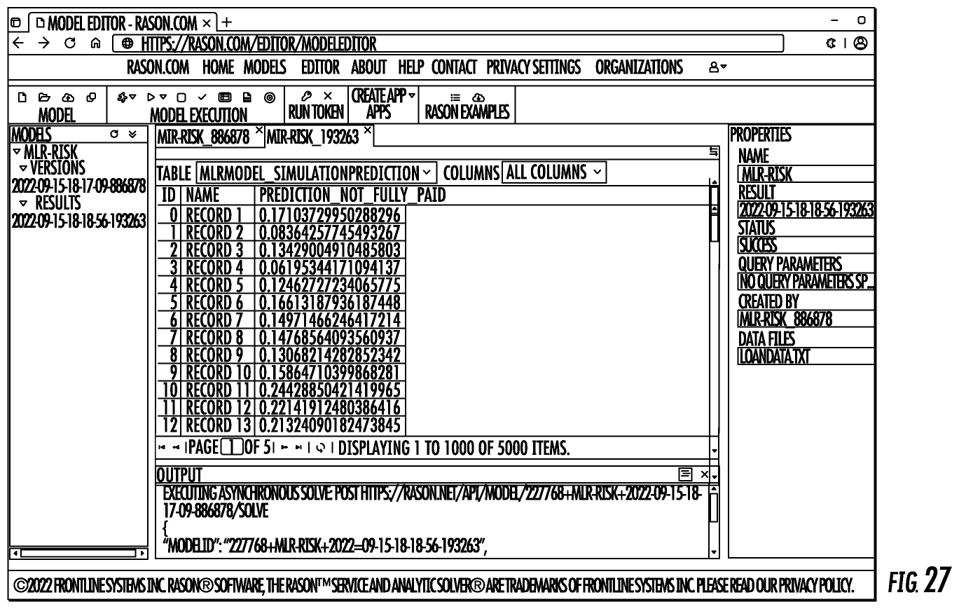

FIG. 24 shows the step to upload or “post” the commands from FIG. 22 to the RASON service; FIG. 25 shows the step to actually train and perform risk analysis on the Regression model in the example; FIG. 26 shows results from the risk analysis delivered to the browser in JSON format; and FIG. 27 shows the same results from the risk analysis delivered in OData format.

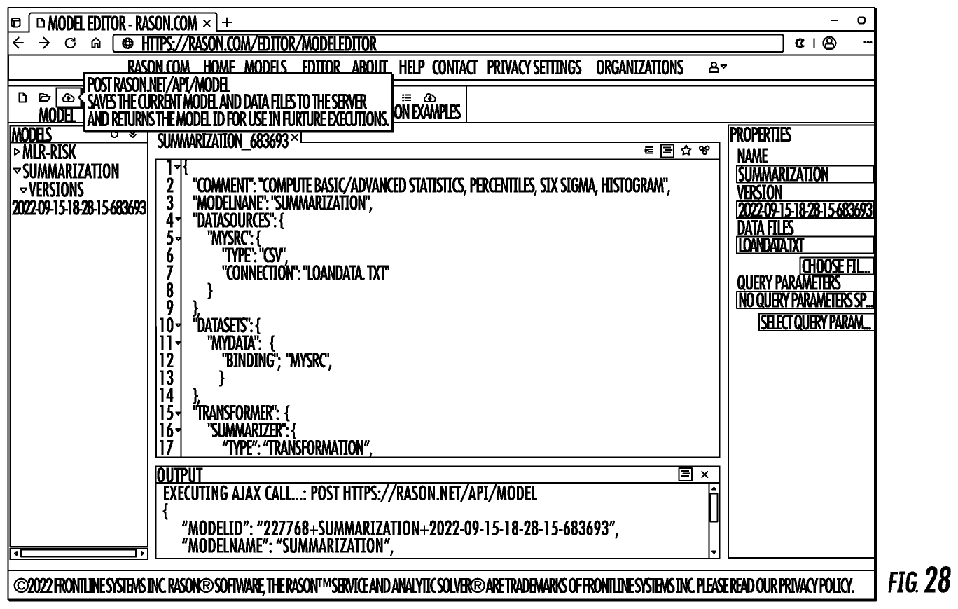

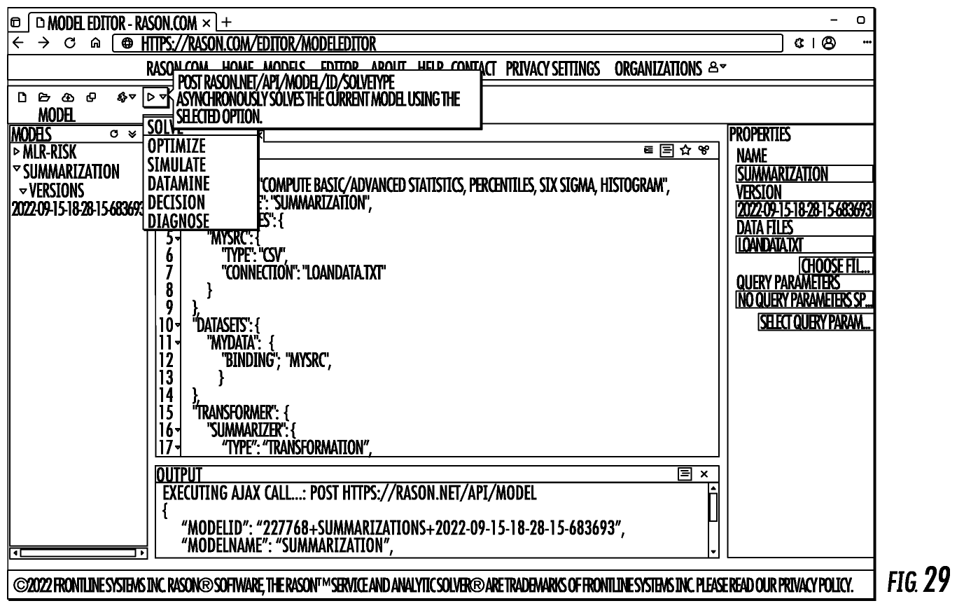

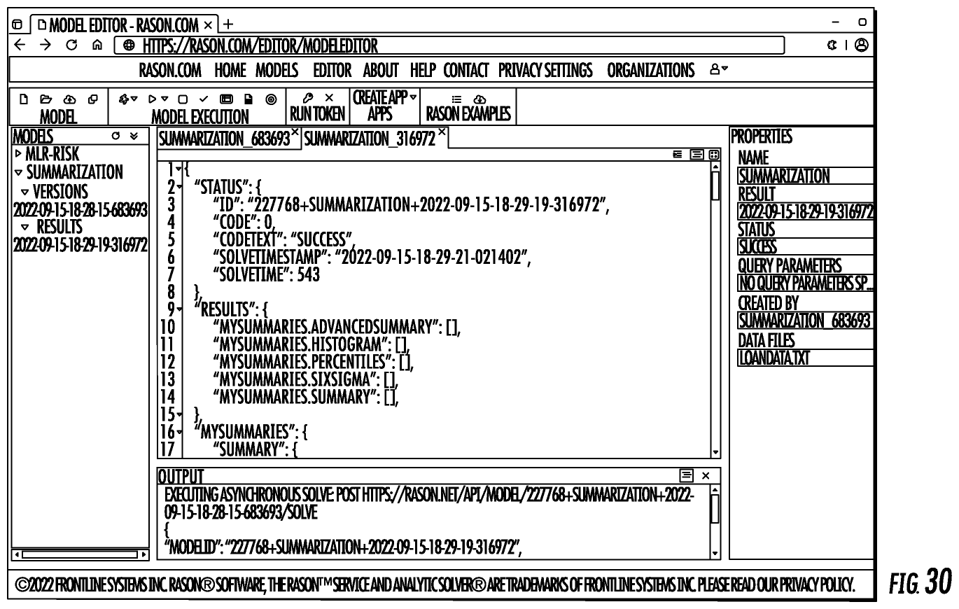

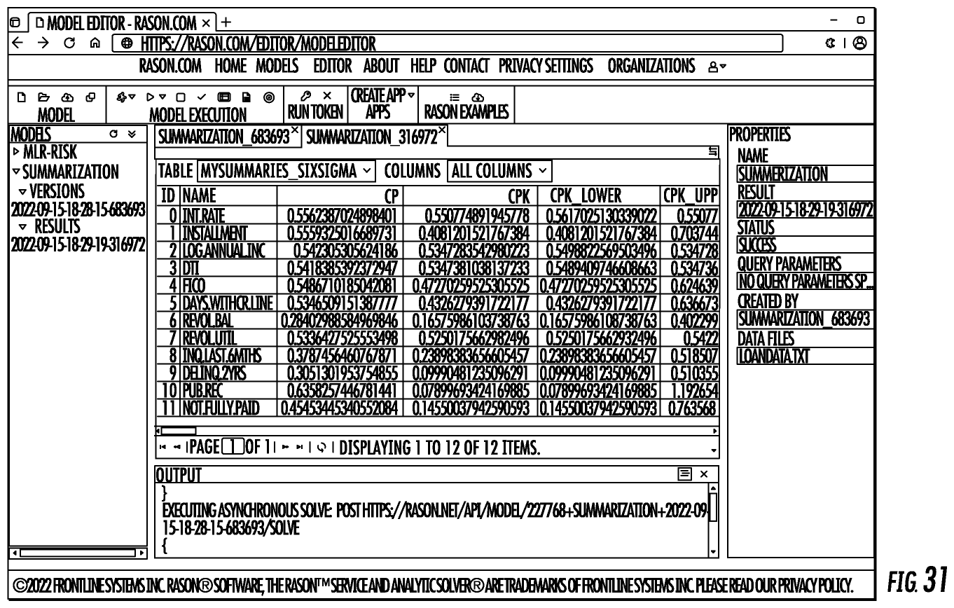

FIGS. 28 to 31 show the same steps and results for the “advanced summary” commands in FIG. 23. Again FIG. 28 shows the step to upload or “post” the commands from FIG. 23 to the RASON service; FIG. 29 shows the step to compute and retrieve the “advanced summary” results; FIG. 30 shows these “advanced summary” results delivered to the browser in JSON format; and FIG. 31 shows the same “advanced summary” results delivered in OData format.

Professional Software Development in a Programming Language

FIGS. 32 through 34 illustrate how a professional software developer who prefers to use a programming language, in this case C#, can use an embodiment of this specification in the inventors' Solver SDK® (Software Development Kit) product to request the same risk analysis and assessment illustrated in FIGS. 2 through 21 using Microsoft Excel. The code makes use of high-level C# classes such as LinearRegression.Estimator and SyntheticDataGenerator, provided by Solver SDK, and calls C# methods such as sdg.transform, model,predict, Summarizer.summary(data.target[TRAINING])), Summarizer.summary(actualPrediction)), Summarizer.summary(syntheticPrediction)), Summarizer.summary(syntheticExpression)), and the Summarizer.advancedSummary methods to generate the comparisons and statistics described earlier for Excel and RASON.

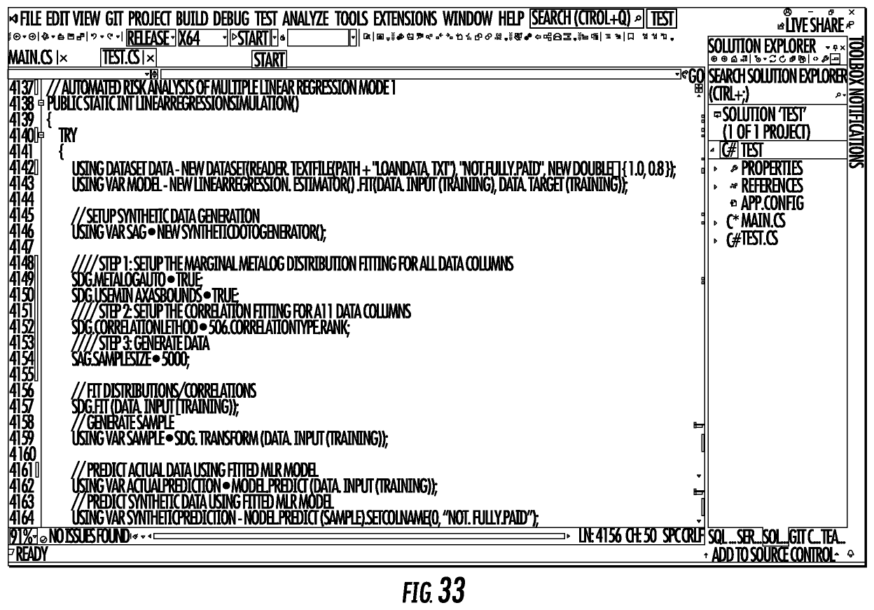

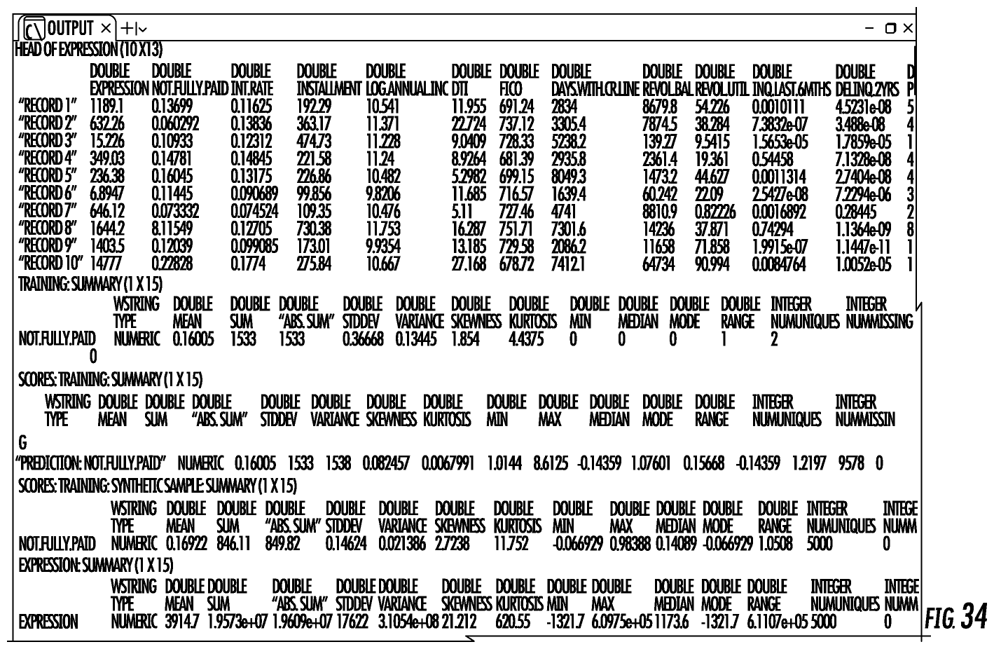

FIGS. 33 and 34 teach the user steps needed to compile, link and run the C# code in FIG. 32 in Microsoft Visual Studio. Visual Studio hosts and runs the C# compiler, which translates the C# statements to executable (.NET Runtime) code, links the code to the Solver SDK dynamic link library, and executes the combined program to perform the risk analysis. FIG. 34 shows the output produced by the series of “console output” statements in the code, such as Console.WriteLine(Summarizer.summary(syntheticPrediction)); These results are in a form that can be easily used to display a user interface or perform further analysis.

What is claimed is:

1. A method to assess at least one of uncertainty or risk in applying a predictive model to future cases wherein the predictive model has been fitted to a dataset of known cases, each comprising input values for a plurality of features with corresponding predictions from the model and associated outcomes from the predictions, the method comprising:
(A) assessing the statistical properties of a plurality of input values for a plurality of features of a plurality of the known cases of the dataset of known cases;
(B) using the assessment to generate a dataset of synthetic cases that exhibits overall statistical properties at least substantially similar to corresponding statistical properties of the dataset of known cases;
(C) applying the predictive model to the dataset of synthetic cases to obtain synthetic predictions for the synthetic cases and associated synthetic outcomes;
(D) analyzing at least one of:
(a) a difference in a distribution of predictions of the model on the synthetic data (synthetic prediction distribution) versus a distribution of predictions of the model on the known data (known prediction distribution); and
(b) a difference in a distribution of outcomes from the predictions of the model on the synthetic data (synthetic outcome distribution) versus a distribution of outcomes from the predictions of the model on the known data (known outcome distribution);
to estimate at least one of an uncertainty or risk of applying the model to future cases.

2. The method of claim 1 wherein the predictive model is at least one of a machine learning model or an ensemble of machine learning models that has been trained on the dataset of known cases.

3. The method of claim 1 comprising determining at least one of a frequency or magnitude of a departure of the predictive model's predictions on the synthetic dataset relative to the predictive model's predictions on the known dataset.

4. The method of claim 1 comprising determining at least one of a frequency or magnitude of a departure of outcomes based on the predictive model's predictions on the synthetic dataset relative to outcomes based on the predictive model's predictions on the known dataset.

5. The method of claim 1 wherein assessing the statistical properties comprises fitting one or more of the plurality of features of a plurality of the known cases of the dataset of known cases to at least one probability distribution.

6. The method of claim 5 comprising fitting a plurality of features of a plurality of the known cases of the dataset of known cases to a set of different probability distributions and selecting a best-fit distribution.

7. The method of claim 6 wherein selecting the best-fit distribution uses a criterion comprising at least one of Anderson-Darling, Kolmogorov-Smirnov, Chi-Squared, Maximum Likelihood, AIC, AICc or BIC.

8. The method of claim 5 wherein the at least one probability distribution comprises at least one of a bounded Metalog probability distribution, a semi-bounded Metalog probability distribution, or an unbounded Metalog probability distribution.

9. The method of claim 6 further comprising fitting a correlation function to one or more of the selected or fitted probability distributions.

10. The method of claim 9 wherein the correlation function comprises at least one of a Clayton, Frank, Gumbel, Gauss or Student copula or positive definite rank-order correlation matrix.

11. The method of claim 1 wherein generating the synthetic cases comprises at least one of Monte Carlo sampling, stratified sampling or Sobol number generation.

12. The method of claim 1 wherein the analyzing utilizes statistical measures of individual or binned values including one or more of mean, variance, extreme values, percentiles, Value at Risk.

13. The method of claim 1 comprising generating and displaying a chart of at least one of:
(a) a difference in the synthetic prediction distribution versus the known prediction distribution; and
(b) a difference in the synthetic outcome distribution versus the known outcome distribution.

14. The method of claim 13 comprising generating and displaying a chart comprising differences in one or more statistical measures between the synthetic prediction distribution versus the known prediction distribution.

15. The method of claim 1 comprising determining whether the predictive model is suitable for production use comprising determining if the predictive model predicts a frequency distribution of results for a synthetic dataset that is comparable to a frequency distribution of results for a known dataset.

16. The method of claim 1 comprising:
(A) determining at least one of an uncertainty or a risk for a plurality of predictive models that produce a comparable prediction;
(B) comparing at least one of the uncertainty or risk for the plurality of predictive models; and
(C) determining, from the comparison, one or more of the predictive models to implement for production use.

17. A system to assess at least one of uncertainty or risk in applying a predictive model to future cases wherein the predictive model has been fitted to a dataset of known cases, each comprising input values for a plurality of features with corresponding predictions from the model and associated outcomes from the predictions, the system comprising at least one processor and at least one operatively associated memory, the at least one processor programmed to perform:
(A) assessing the statistical properties of a plurality of input values for a plurality of features of a plurality of the known cases of the dataset of known cases;
(B) using the assessment to generate a dataset of synthetic cases that exhibits overall statistical properties at least substantially similar to corresponding statistical properties of the dataset of known cases;
(C) applying the predictive model to the dataset of synthetic cases to obtain synthetic predictions for the synthetic cases and associated synthetic outcomes;
(D) analyzing at least one of:
(a) a difference in a distribution of predictions of the model on the synthetic data (synthetic prediction distribution) versus a distribution of predictions of the model on the known data (known prediction distribution); and
(b) a difference in a distribution of outcomes from the predictions of the model on the synthetic data (synthetic outcome distribution) versus a distribution of outcomes from the predictions of the model on the known data (known outcome distribution);
to estimate at least one of an uncertainty or risk of applying the model to future cases.

18. The system of claim 17 wherein the predictive model is at least one of a machine learning model or an ensemble of machine learning models that has been trained on the dataset of known cases.

19. The system of claim 17 wherein the at least one processor is programmed to perform determining at least one of a frequency or magnitude of a departure of the predictive model's predictions on the synthetic dataset relative to the predictive model's predictions on the known dataset.

20. The system of claim 17 wherein the at least one processor is programmed to perform determining at least one of a frequency or magnitude of a departure of outcomes based on the predictive model's predictions on the synthetic dataset relative to outcomes based on the predictive model's predictions on the known dataset.

21. The system of claim 17 wherein assessing the statistical properties comprises fitting one or more of the plurality of features of a plurality of the known cases of the dataset of known cases to at least one probability distribution.

22. The system of claim 21 comprising fitting a plurality of features of a plurality of the known cases of the dataset of known cases to a set of different probability distributions and selecting a best-fit distribution.

23. The system of claim 21 wherein the at least one probability distribution comprises at least one of a bounded Metalog probability distribution, a semi-bounded Metalog probability distribution, or an unbounded Metalog probability distribution.

24. The system of claim 22 wherein the at least one processor is programmed to perform fitting a correlation function to one or more of the selected or fitted probability distributions.

25. The system of claim 17 wherein generating the synthetic cases comprises at least one of Monte Carlo sampling, stratified sampling or Sobol number generation.

26. The system of claim 17 wherein the analyzing utilizes statistical measures of individual or binned values including one or more of mean, variance, extreme values, percentiles, Value at Risk.

27. The system of claim 17 wherein the at least one processor is programmed to perform generating and displaying a chart of at least one of:
(a) a difference in the synthetic prediction distribution versus the known prediction distribution; and
(b) a difference in the synthetic outcome distribution versus the known outcome distribution.

28. The system of claim 27 wherein the at least one processor is programmed to perform generating and displaying a chart comprising differences in one or more statistical measures between the synthetic prediction distribution versus the known prediction distribution.

29. The system of claim 17 wherein the at least one processor is programmed to perform determining whether the predictive model is suitable for production use comprising determining if the predictive model predicts a frequency distribution of results for a synthetic dataset that is comparable to a frequency distribution of results for a known dataset.

30. The system of claim 17 wherein the at least one processor is programmed to perform:
(A) determining at least one of an uncertainty or a risk for a plurality of predictive models that produce a comparable prediction;
(B) comparing at least one of the uncertainty or risk for the plurality of predictive models; and
(C) determining, from the comparison, one or more of the predictive models to implement for production use.

31. A computer-readable medium comprising computer-executable instructions that when executed by at least one processor cause the at least one processor to perform a method to assess at least one of uncertainty or risk in applying a predictive model to future cases wherein the predictive model has been fitted to a dataset of known cases, each comprising input values for a plurality of features with corresponding predictions from the model and associated outcomes from the predictions, the method comprising:
(A) assessing the statistical properties of a plurality of input values for a plurality of features of a plurality of the known cases of the dataset of known cases;
(B) using the assessment to generate a dataset of synthetic cases that exhibits overall statistical properties at least substantially similar to corresponding statistical properties of the dataset of known cases;
(C) applying the predictive model to the dataset of synthetic cases to obtain synthetic predictions for the synthetic cases and associated synthetic outcomes;
(D) analyzing at least one of:
(a) a difference in a distribution of predictions of the model on the synthetic data (synthetic prediction distribution) versus a distribution of predictions of the model on the known data (known prediction distribution); and
(b) a difference in a distribution of outcomes from the predictions of the model on the synthetic data (synthetic outcome distribution) versus a distribution of outcomes from the predictions of the model on the known data (known outcome distribution);
to estimate at least one of an uncertainty or risk of applying the model to future cases.

32. The computer-readable medium of claim 31 wherein the predictive model is at least one of a machine learning model or an ensemble of machine learning models that has been trained on the dataset of known cases.

33. The computer-readable medium of claim 31 wherein the method comprises determining at least one of a frequency or magnitude of a departure of the predictive model's predictions on the synthetic dataset relative to the predictive model's predictions on the known dataset.

34. The computer-readable medium of claim 31 wherein the method comprises determining at least one of a frequency or magnitude of a departure of outcomes based on the predictive model's predictions on the synthetic dataset relative to outcomes based on the predictive model's predictions on the known dataset.

35. The computer-readable medium of claim 31 wherein assessing the statistical properties which comprises fitting one or more of the plurality of features of a plurality of the known cases of the dataset of known cases to at least one probability distribution.

36. The computer-readable medium of claim 35 wherein the method comprises fitting a plurality of features of a plurality of the known cases of the dataset of known cases to a set of different probability distributions and selecting a best-fit distribution.

37. The computer-readable medium of claim 35 wherein the at least one probability distribution comprises at least one of a bounded Metalog probability distribution, a semi-bounded Metalog probability distribution, or an unbounded Metalog probability distribution.

38. The computer-readable medium of claim 36 wherein the method further comprises fitting a correlation function to one or more of the selected or fitted probability distributions using as a correlation function.

39. The computer-readable medium of claim 31 wherein generating the synthetic cases comprises at least one of Monte Carlo sampling, stratified sampling or Sobol number generation.

40. The computer-readable medium of claim 31 wherein the analyzing utilizes statistical measures of individual or binned values including one or more of mean, variance, extreme values, percentiles, Value at Risk.

41. The computer-readable medium of claim 31 wherein the method comprises generating and displaying a chart of at least one of:
(a) a difference in the synthetic prediction distribution versus the known prediction distribution; and
(b) a difference in the synthetic outcome distribution versus the known outcome distribution.

42. The computer-readable medium of claim 41 wherein the method comprises generating and displaying a chart comprising differences in one or more statistical measures between the synthetic prediction distribution versus the known prediction distribution.

43. The computer-readable medium of claim 31 wherein the method comprises determining whether the predictive model is suitable for production use comprising determining if the predictive model predicts a frequency distribution of results for a synthetic dataset that is comparable to a frequency distribution of results for a known dataset.

44. The computer-readable medium of claim 31 wherein the method comprises:
(A) determining at least one of an uncertainty or a risk for a plurality of predictive models that produce a comparable prediction;
(B) comparing at least one of the uncertainty or risk for the plurality of predictive models; and
(C) determining, from the comparison, one or more of the predictive models to implement for production use.
